(19) United States
(12) Patent Application Publication
(10) Pub. No.: US 2024/0290028 A1
(43) Pub. Date: Aug. 29, 2024

(54) NON-TRANSITORY COMPUTER READABLE MEDIUM, INFORMATION PROCESSING APPARATUS, AND INFORMATION PROCESSING METHOD

(71) Applicant: Cluster, Inc., Tokyo (JP)

(72) Inventors: Daiki HANDA, Tokyo (JP); Hiroyuki TOMINE, Tokyo (JP)

(73) Assignee: Cluster, Inc., Tokyo (JP)

(21) Appl. No.: 18/585,095

(22) Filed: Feb. 23, 2024

(30) Foreign Application Priority Data
Feb. 28, 2023 (JP) 2023-029021
Sep. 22, 2023 (JP) 2023-156604

(51) Int. Cl. G06T 15/00; G06F 16/583; G06V 20/40; H04N 23/61

(52) U.S. Cl. CPC G06T 15/00; G06F 16/583; G06V 20/44; H04N 23/61

(57) ABSTRACT

An information processing apparatus that effectively utilizes information regarding a virtual photograph and information regarding a virtual reality space by utilizing characteristics of the virtual reality space is configured to acquire capturing information including photograph information regarding a virtual photograph captured by a virtual camera used in a virtual reality space and information specifying a virtual reality space in which the virtual photograph is captured. Additionally, object information regarding one or more of the objects included in a capturing range of the virtual camera at a time that the virtual photograph is captured and a determination result of determining, based on the camera information and the object information, whether or not to be a captured object shown in the virtual photograph for each of the one or more objects included in the capturing range is acquired. Further, the photograph information is associated with the space specifying information.

### CROSS-REFERENCE TO RELATED APPLICATIONS

This application claims priority to Japanese Patent Application Nos. 2023-029021, filed Feb. 28, 2023, and 2023-156604, filed Sep. 22, 2023, the entire contents of each are hereby incorporated by reference.

### BACKGROUND

### Technical Field

The present disclosure relates to a non-transitory computer readable medium, an information processing apparatus, and an information processing method.

### Description of the Related Art

Virtual reality technology is a technology that allows people to experience a virtual world built on a computer as if it were real. This virtual world is a world constituted by various virtual objects (hereinafter simply referred to as “objects”), and is called a virtual reality space.

One of the objects is a virtual camera imitating a real camera. The virtual camera may be operated by an avatar in a virtual reality space, for example. The avatar is, for example, an object used as a virtual self of a real person (hereinafter referred to as a “participant”) when the real person participates in the virtual reality space.

Conventionally, there is a technique for automatically associating information regarding a virtual photograph captured using this virtual camera with information regarding an object shown in the virtual photograph (for example, JP 6952065 B2).

### SUMMARY

One of characteristics of the virtual reality space is that what state the virtual reality space in which a participant currently participates is in is grasped by the computer that provides the virtual reality space. With this characteristic, the computer that provides the virtual reality space can grasp, for example, what state the virtual reality space in which the virtual photograph is captured is in when the virtual photograph is captured using the virtual camera.

However, there is a problem that only the association between the information regarding the virtual photograph and the information regarding the object is performed in the conventional technology, and the characteristics of the virtual reality space as described above are not utilized.

The present disclosure solves the above problems, and an object thereof is to effectively utilize information regarding a virtual photograph and information regarding a virtual reality space by utilizing characteristics of the virtual reality space.

A non-transitory computer-readable medium according to the present disclosure stores a program causing one or more computers to function as an information processing apparatus including: a capturing information acquisition unit that acquires capturing information including camera information regarding a virtual camera used in a virtual reality space and photograph information regarding a virtual photograph captured by the virtual camera; an object information acquisition unit that acquires object information regarding, among one or more objects arranged in the virtual reality space, one or more of the objects included in a capturing range of the virtual camera when the virtual photograph is captured; a determination result acquisition unit that acquires a determination result of determining, on the basis of the camera information and the object information, whether or not to be a captured object shown in the virtual photograph for each of the one or more objects included in the capturing range; and an association unit that associates the object information with the photograph information on the basis of the determination result.

According to the present disclosure, it is possible to effectively utilize information regarding a virtual photograph and information regarding a virtual reality space by utilizing characteristics of the virtual reality space.

### BRIEF DESCRIPTION OF THE DRAWINGS

FIG. 1 is a block diagram illustrating a configuration of an information processing system according to a first embodiment;

FIG. 2 is a block diagram illustrating hardware components that implement functions of an information processing apparatus according to the first embodiment;

FIG. 3 is a conceptual view illustrating an example of virtual photographing;

FIG. 4 is a screen view illustrating an example of a virtual photograph;

FIG. 5 is a screen view illustrating an example of object designation in the virtual photograph;

FIG. 6 is a screen view illustrating a display example of objects and object information in the virtual photograph; and

FIG. 7 is a flowchart illustrating an information processing method according to the first embodiment.

### DETAILED DESCRIPTION

### First Embodiment

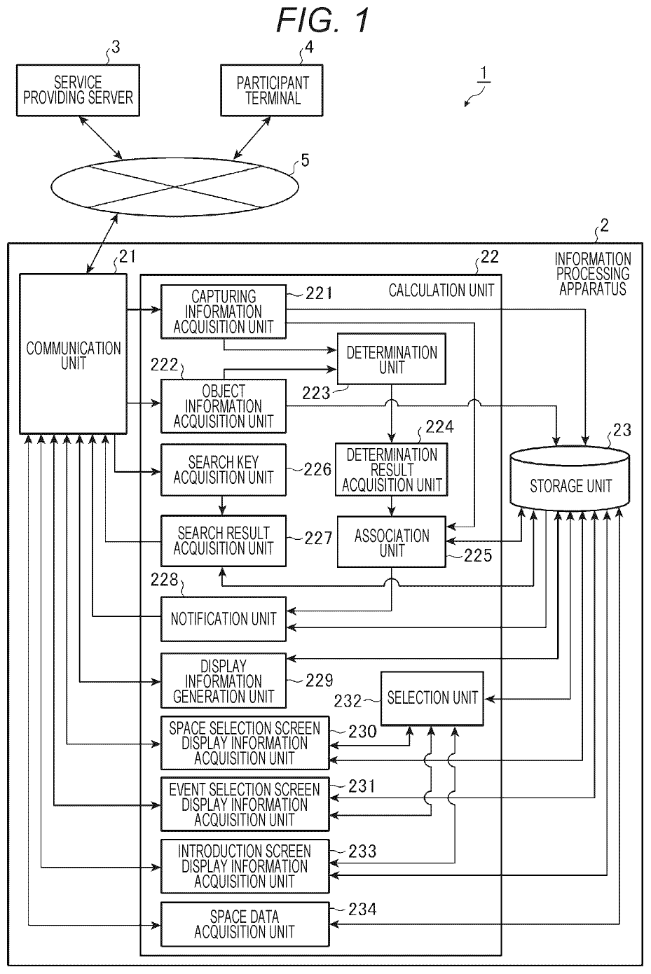

FIG. 1 is a block diagram illustrating a configuration of an information processing system 1 according to a first embodiment. In FIG. 1, the information processing system 1 is a system in which an information processing apparatus 2, a service providing server 3, and a participant terminal 4 are connected via a network 5. As the network 5, an existing electric communication line can be used. The network 5 is, for example, the Internet. The information processing apparatus 2, the service providing server 3, and the participant terminal 4 can communicate with each other via the network 5.

### Outline of Information Processing Apparatus

The information processing apparatus 2 acquires capturing information including photograph information regarding a virtual photograph captured by a virtual camera used in a virtual reality space and space specifying information specifying the virtual reality space in which the virtual photograph is captured using the virtual camera among a plurality of virtual reality spaces different from each other, and associates the photograph information with the space specifying information.

In the information processing system 1, a part or all of the functions of the information processing apparatus 2 may be provided in the service providing server 3 or in the participant terminal 4. Furthermore, in the information processing system 1, a part or all of the functions of the information processing apparatus 2 may be provided by the service providing server 3 and the participant terminal 4 in an overlapping manner.

Hereinafter, in a case where there is no particular description, it is assumed that one server having a physical configuration independent of the service providing server 3 and the participant terminal 4 includes all the functions of the information processing apparatus 2. However, all of the functions of the information processing apparatus 2 may be implemented by one server or may be implemented by a plurality of servers.

Details of the information processing apparatus 2 will be described later.

### Service Providing Server

The service providing server 3 provides a service related to a virtual reality space represented by space data to users such as participants in the virtual reality space via the network 5. For example, a person who wishes to use the service can register as a user of the service by accessing the service providing server 3 from his or her own terminal and performing a predetermined procedure. The predetermined procedure includes, for example, registration of a name (real name or handle name) desired by the user as a name for identifying the user. The service providing server 3 assigns a unique ID (hereinafter referred to as a “user ID”) to the registered user, associates the user ID with information regarding the user such as the name of the user, and manages the user. The service is provided to the user through, for example, a service application installed in a terminal used by the user such as the participant terminal 4.

The service providing server 3 manages three-dimensional data (hereinafter referred to as “space data”) of the virtual reality space. The service providing server 3 can manage a plurality of different pieces of space data. The service providing server 3 manages the space data by assigning a unique ID as metadata to each of the plurality of space data.

In addition, the service providing server 3 may assign, as metadata, a unique ID indicating a space creator (hereinafter referred to as a “space creator ID”), a unique ID indicating an event organizer (hereinafter referred to as an “organizer ID”), or a unique ID indicating a space observer (hereinafter referred to as an “observer ID”) to each of the plurality of space data.

The space creator is a person who has created the space data excluding the three-dimensional data of the avatar. The space creator can use a terminal for space creation to create, in a known manner, space data for representing the virtual reality space in a state where the avatar is not arranged. The terminal for space creation may be, for example, a smartphone, a tablet terminal, or a personal computer (PC) owned by the space creator himself. Then, in the service provided by the service providing server 3, for example, any space creator having the above-described user ID can create space data by operating the terminal for space creation, and upload the created space data to the service providing server 3. At that time, the space creator can upload, with respect to the virtual reality space represented by the space data created by himself or herself, metadata of the space data including an arbitrary and unique name given by himself or herself, a thumbnail image of the virtual reality space, an explanatory sentence of what content the virtual reality space has, and the like. The name of the space creator may be, for example, a real name or a handle name. The thumbnail image is a two-dimensional still image in a case where the virtual reality space is viewed from a certain viewpoint, and is created by the space creator as an image that well represents features of the virtual reality space created by himself or herself, for example. When the space data is uploaded from the terminal for space creation, the service providing server 3 assigns a unique ID to the space data, associates the user ID of the space creator therewith, and manages metadata of the space data such as the space data and the name.

The event organizer is a person who uses a virtual reality space represented by space data as a place where an event is held. After acquiring the above-described user ID, a person who wishes to hold various events using the virtual reality space represented by the space data managed by the service providing server 3 can register an event using the virtual reality space by, for example, accessing the service providing server 3 from the terminal used by the person himself or herself and inputting information such as the type of a desired event, a thumbnail image of the event, the name of the event, the description of what the event is about, space data desired to be used, and the like. For example, the service providing server 3 manages an event by associating information specifying a registered event, the type of the event, a thumbnail image of the event, a name of the event, and an ID unique to space data used for the event with a user ID of a person (event organizer) who has registered the event (hereinafter also referred to as “organizer ID”).

The information specifying the registered event is, for example, an ID (hereinafter referred to as an “event ID”) unique to the event. When registering an event, the service providing server 3 assigns a unique event ID to the event. The event ID may be included in the metadata of the space data. Hereinafter, the organizer ID or the event ID is also referred to as “event information”.

For example, as long as permission is obtained from the space creator or the like of the virtual reality space, the event organizer can arbitrarily select in which virtual reality space and when to hold one event of a certain content. For example, the event organizer may hold one event of a certain content a plurality of times while changing the date and time in one virtual reality space while the content of the event is substantially the same, may hold the event in the same time slot of the same day in a plurality of virtual reality spaces different from each other, may hold the event at different dates and times in a plurality of virtual reality spaces different from each other, or may hold the event at a date and time when time slots partially overlap in a plurality of virtual reality spaces different from each other. In such a case, even one event having substantially the same contents can be distinguished and given a unique event ID every time the event is held in different situations (different virtual reality space or different date and time). Hereinafter, a group of a plurality of events which are events having substantially the same contents but are held in different situations is referred to as a “same content related event group”.

In addition, the event organizer may hold an event having similar contents, which cannot be said to be an event having substantially the same contents as one event, or a series of events having contents following the contents of one event. Each time these events are held, a unique event ID is also assigned. Hereinafter, a group including a plurality of events having similar contents is referred to as a “similar content related event group”, and a group including a plurality of events having a series of contents is referred to as a “series of content related event group”.

In addition, the event organizer may manage a plurality of events held at different dates and times in time series as channels including related events. Hereinafter, a group including a plurality of events in one channel is referred to as a “same channel event group”.

Furthermore, regardless of the contents of the event, a group of a plurality of events held by a single event organizer is referred to as a “same organizer related event group”, and among them, a group including a plurality of events designated as being related by a single event organizer is referred to as a “designated related event group”.

Hereinafter, the same content related event group, the similar content related event group, the series of content related event group, the same channel event group, the same organizer related event group, and the designated related event group are collectively referred to as a “related event group”.

In the service providing server 3, a related event group including a plurality of events having a predetermined specific relationship (hereinafter simply referred to as a “specific relationship”) with each other as described above is stored and managed in a storage unit (hereinafter referred to as a “service providing server storage unit”), accessible from the service providing server 3 for each related event group, for example, by associating event IDs of a plurality of events included in each related event group with each other. A unique ID (hereinafter referred to as a “related event group ID”) may be assigned to each of the plurality of related event groups different from each other by the service providing server 3. Hereinafter, with respect to a certain arbitrary event included in one related event group, another arbitrary event included in the relational event group, that is, an event having a specific relationship with the one event is referred to as a “relational event”.

What kind of relationship between the events is set as a related event having a specific relationship is determined in advance by, for example, an event organizer or a service provider using the service providing server 3. Information describing the specific relationship (hereinafter referred to as “specific relationship description information”) is stored in the service providing server storage unit.

For example, when an event is registered by an event organizer, the service providing server 3 may refer to the specific relationship description information, and perform, in a case where a related event group in which the event is to be included already exists, processing of including the event in the related event group, and create, in a case where a related event exists but a related event group does not exist yet, the related event group, for example, assign a related event group ID, and store the created group in the service providing server storage unit.

Note that one event may be included in a plurality of related event groups.

The space observer is a person who monitors whether the virtual reality space expressed by the space data is appropriately used by participants. The space observer is, for example, a person in charge of monitoring the use of the virtual reality space among persons belonging to an organization such as a company that provides a service using the service providing server 3. The service providing server 3 manages the space data by associating an ID (for example, an employee ID or the like) of a person in charge of the monitoring with an ID unique to the space data.

Hereinafter, when simply referred to as “space data”, it is assumed that metadata of the space data is also included.

One space data includes three-dimensional data of each of one or more objects arranged in the virtual reality space represented by the space data.

The three-dimensional data of an object includes, for example, three-dimensional shape information, size information, chromatic information, position information, and orientation information of the object. The position information is represented by, for example, coordinate values of global coordinates set in the virtual reality space. The orientation information is represented by, for example, a rotation angle with respect to a coordinate axis of the global coordinates set in the virtual reality space.

Furthermore, in a case where a participant participates in a virtual reality space represented by certain space data as an avatar, the objects also includes an avatar. In a case where an object is an avatar, the three-dimensional data of the object includes posture information of the avatar in addition to each piece of information such as the three-dimensional shape information described above. The posture information is represented by, for example, position information or orientation information of each of a plurality of bones constituting the avatar.

Furthermore, the three-dimensional data of an object may include, as metadata, an ID unique to the object (hereinafter referred to as an “object ID”), an object name, an ID unique to the owner of the object (hereinafter referred to as “owner ID”), an ID unique to the creator of the object (hereinafter referred to as an “object creator ID”), an ID unique to the seller of the object (hereinafter referred to as a “seller ID”), or an ID unique to a favorite registrant of the object (hereinafter referred to as the “favorite registrant ID”).

The owner of an object is a person who manages or controls the three-dimensional data of the object. For example, a person who has purchased three-dimensional data of an avatar from a seller of the three-dimensional data of the avatar is a person who manages or controls the three-dimensional data of the avatar and is the owner of the avatar. A participant may join the virtual reality space using an avatar that he or she owns the three-dimensional data. Therefore, the service providing server 3 can use, for example, the user ID of the participant participating in the virtual reality space using the avatar as the owner ID of the avatar.

The creator of an object is the person who has created the three-dimensional data of the object. For example, the object includes various structures in the virtual reality space, various parts constituting the structures, vegetation, an avatar, an item that can be used by an avatar, and the like. All the three-dimensional data of these objects are created by someone, and thus the person who has created the three-dimensional data of each object can provide the three-dimensional data to another person such as a space creator, for example, after assigning an ID unique to himself or herself as metadata of the three-dimensional data of the object. Therefore, the metadata of the three-dimensional data of the object included in the space data managed by the service providing server 3 can include the object creator ID of the object.

The service providing server 3 may manage, as the object creator ID, the user ID of the user who has uploaded the object to the service providing server 3 for the purpose of providing an object that can be used for a fee or for free in the provided service. Note that the user who uploads the object may also include an object seller.

The seller of an object is a person who sells three-dimensional data of the object. A person who sells three-dimensional data of an object can give an ID unique to himself or herself as metadata of the three-dimensional data of the object, and then sell the three-dimensional data to others such as participants, for example. Therefore, the metadata of the three-dimensional data of the object included in the space data managed by the service providing server 3 can include the seller ID of the object.

Note that the object may be sold via the service providing server 3. For example, after acquiring the above-described user ID, the seller of the object accesses the service providing server 3 from the terminal used by himself or herself to register the three-dimensional data of the object to be sold, a sales name or an object name of the object, the sales price, and the like, to thereby sell the object to another user.

The favorite registrant of an object is, for example, a person who has registered information of what is called “favorite” by performing a specific operation on three-dimensional data of a sold object. The favorite registrant ID specifying the person who has registered the favorite can be managed by a server or the like in association with the three-dimensional data or the object ID of the sold object. The service providing server 3 can acquire the favorite registrant ID managed in association with the three-dimensional data or the object ID of the object by accessing the server or the like as necessary for the object included in the space data to be managed.

Hereinafter, it is assumed that both the seller and the registrant who can register the favorite are users of the service provided by the service providing server 3 and have a user ID. In this case, the seller ID may be common to the user ID, and the favorite registrant ID may also be common to the user ID.

Hereinafter, when simply referred to as “three-dimensional data of an object”, it is assumed that metadata of the three-dimensional data of the object is also included.

For example, the service providing server 3 may duplicate the space data excluding the three-dimensional data of the avatar and create the space data as one or more new duplicates. Hereinafter, the space data newly created by duplication is referred to as “duplicated space data”.

For example, in a case where the number of participants who participate as an avatar in a certain space data is limited, or in a case where only a specific participant wants to participate in a certain space data, if the duplicated space data as a duplicate of the space data excluding the three-dimensional data of the avatar can be used, the convenience for the participants is high.

The service providing server 3 also assigns a unique ID to the duplicated space data and manages the duplicated space data. The service providing server 3 manages an ID unique to the duplicated space data in association with, for example, an ID unique to the space data of the duplication source. Hereinafter, the ID unique to the space data and the ID unique to the duplicated space data are also collectively referred to as “space data ID”. In addition, hereinafter, the space data and the duplicated space data are also collectively referred to simply as “space data”.

The service providing server 3 provides the participants with a service using a virtual reality space represented by space data via the network 5.

Note that, in FIG. 1, the information processing system 1 includes only one service providing server 3. However, the information processing system 1 may include one or more service providing servers 3. In a case where the information processing system 1 includes a plurality of service providing servers 3, for example, each of the service providing servers 3 may manage different space data from each other, or in a case where one service providing server 3 manages certain space data, another service providing server 3 may manage duplicated space data as a copy of the space data.

In the following description, it is assumed that the information processing system 1 includes one service providing server 3 as illustrated in FIG. 1.

The service providing server 3 can access the service providing server storage unit. The service providing server storage unit stores space data for representing one or more virtual reality spaces. In addition, the service providing server storage unit stores a user ID, a user name at the time of using the service registered by the user indicated by the user ID, information indicating a notification means to the user indicated by the user ID (for example, an e-mail address, an in-application notification of a service application, or the like), and the like. In addition, the service providing server storage unit stores three-dimensional data of an object, an object creator ID, sales information in a case where the object is sold or has been sold, a favorite registrant ID, or the like in association with information that can specify the object, such as an object ID. The sales information of the object may include, for example, a seller ID of the object, a price at which the object is or has been sold or a date on which the object has been sold, a date on which the sale of the object has started, a sale ID unique to a particular sale indicating a case where the object has been sold and purchased at the particular sale, a normal price sale ID indicating a case where the object has been sold and purchased at a normal price, or the like.

### Participant Terminal

The participant terminal 4 is a terminal used when the participant participates in the virtual reality space. The participant accesses the service providing server 3 using the participant terminal 4 and downloads desired space data to the participant terminal 4. The participant participates as an avatar in the virtual reality space represented by the space data by using the participant terminal 4. The participant may also participate in the virtual reality space in a manner of simply viewing the virtual reality space without using the avatar.

In a case where the participant participates in the virtual reality space as an avatar, the participant can change the state of the avatar or other objects, for example, by moving the avatar, changing the posture of the avatar, moving the avatar to move or use another object, or the like in the virtual reality space by operating the participant terminal 4.

The participant terminal 4 is, for example, a smartphone, a tablet terminal, or a PC. In addition, the participant terminal 4 may be a head mounted display that is used together with a controller and has a communication function.

For example, the participant wearing the head mounted display on the head and holding the controller in the hand can operate the virtual reality space displayed on the head mounted display by moving the head or the hand or operating a button or the like of the controller.

That is, the participant terminal 4 is only required to be a device that displays the virtual reality space and can operate the virtual reality space.

### Sharing of Space Data

In a case where the participant participates in the virtual reality space as an avatar by using the participant terminal 4, when the participant operates the participant terminal 4 to change the state of the avatar or another object, the participant terminal 4 modifies the downloaded space data on the basis of information indicating the operation (hereinafter referred to as “operation information”), and changes the state of the avatar or another object in the virtual reality space. Further, the participant terminal 4 transmits the operation information to the service providing server 3. The service providing server 3 corrects the space data of the virtual reality space in which the avatar described above participates among the managed space data on the basis of the operation information acquired from the participant terminal 4, and changes the state of the avatar or another object in the virtual reality space.

In this way, the participant terminal 4 and the service providing server 3 can share the states of an avatar and an object in one and the same virtual reality space in substantially real time. In other words, the participant terminal 4 and the service providing server 3 can share the space data of one and the same virtual reality space in substantially real time.

Here, FIG. 1 illustrates only one participant terminal 4. However, the information processing system 1 usually includes a plurality of participant terminals 4.

For example, in a case where a plurality of participants participates as avatars in one and the same virtual reality space from their own participant terminals 4, when acquiring operation information from one participant terminal 4, the service providing server 3 also transmits the operation information to all the other participant terminals 4. When acquiring the above-described operation information from the service providing server 3, all the other participant terminals 4 correct the downloaded space data and change the state of the avatar or another object in the virtual reality space.

In this way, the plurality of participant terminals 4 and the service providing server 3 can share the states of an avatar and an object in one and the same virtual reality space in substantially real time. In other words, the plurality of participant terminals 4 and the service providing server 3 can share the space data of one and the same virtual reality space in substantially real time.

### Virtual Camera

One of the objects is a virtual camera imitating a real camera. The virtual camera is an object used in the virtual reality space in order to define a capturing range in the virtual reality space according to a position, an orientation, and the like of the virtual camera and record (as a virtual photograph) a state of the virtual reality space within the capturing range visible from the position of the virtual camera at a specific moment.

The virtual camera can be used to capture a virtual photograph in which an object existing in the virtual reality space is determined to be a captured object, for example, typically by being held and operated by an avatar in the virtual reality space, as in a case where a person holds and operates the camera in a real space to capture a photograph in which an object existing in the virtual reality space is the subject. Furthermore, the virtual camera can be used to capture a group (virtual) photograph or a selfie virtual photograph of a plurality of avatars existing in the virtual reality space, for example, by being fixed and operated at a predetermined position by an avatar in the virtual reality space, similar to capturing of a group photograph or what is called a selfie photograph in the real space as if a person fixes the camera to a tripod and arranges the camera at a predetermined position in the real space and then operates the camera.

That is, this virtual camera is different from, for example, one that has a role of simply determining from which position in the virtual reality space and at which angle the virtual reality space is viewed, that is, simply determining the viewpoint (it is also generally called a camera, hereinafter referred to as a “viewpoint camera”) in order to display the virtual reality space on the display of the participant terminal 4.

Since the virtual camera is one of objects, the entity thereof is three-dimensional data including three-dimensional shape information, size information, chromatic information, position information, and orientation information, similarly to other objects. The three-dimensional data of the virtual camera includes information specific to the virtual camera, such as an angle of view, as metadata, in addition to the above information.

### Virtual Photograph

A virtual photograph shows one or more objects in the virtual reality space as viewed from the position and orientation of the virtual camera at the time when the virtual camera is operated for capturing (hereinafter referred to as “at the time of capturing”). The virtual photograph is a two-dimensional image, and its entity is two-dimensional data having a predetermined number of pixels in each of a vertical direction and a horizontal direction like a real digital photograph.

Furthermore, the entity of the virtual photograph is two-dimensional data, but may be one of objects. That is, the two-dimensional data of the virtual photograph can be handled as three-dimensional data having no thickness. The three-dimensional data of the virtual photograph includes three-dimensional shape information, size information, chromatic information, position information, and orientation information, similarly to other objects.

For example, the avatar in the virtual reality space can change its state by holding, moving, and the like of the virtual photograph similar to other objects.

The virtual photograph is generated by at least one of the participant terminal 4 or the service providing server 3.

For example, when an operation for capturing a virtual photograph is performed on the virtual camera, first, one or more objects included in the capturing range of the virtual camera at the time of capturing among one or more objects arranged in the virtual reality space are specified (hereinafter referred to as “in-range object specification”). The capturing range of the virtual camera at the time of capturing is specified on the basis of position information, orientation information, angle of view information, and the like of the virtual camera at the time of capturing. Hereinafter, information including at least position information, orientation information, and angle of view information of the virtual camera at the time of capturing is also referred to as “camera information”.

The capturing range has a three-dimensional shape, and has, for example, a quadrangular pyramid shape with the position of the virtual camera as a vertex, or a quadrangular pyramid shape excluding a portion from the vertex position of the quadrangular pyramid to a certain distance.

One or more objects included in the capturing range of the virtual camera at the time of capturing can be specified from three-dimensional shape information indicating the capturing range, three-dimensional shape information and size information of one or more objects arranged in the virtual reality space, position information and orientation information at the time of capturing, and the like.

When the in-range object specification is performed, next, for a part or all of one or more objects specified (hereinafter referred to as an “in-range object”), it is determined whether or not the part or all become invisible as viewed from the position of the virtual camera due to the presence of other objects acting as covering objects (hereinafter referred to as “covering determination”).

For example, in a case where two objects are arranged in the virtual reality space, both are within the capturing range of the virtual camera, and one object is in front of the other object as viewed from the position of the virtual camera, one object is shown in the virtual photograph, but a portion of the other object behind the one object is not shown in the virtual photograph. Depending on the size and position of one object and the relationship with the size and position of the other object, the entire other object may be behind the one object as viewed from the position of the virtual camera, and the other object may not be shown in the virtual photograph at all.

The covering determination is processing of determining whether or not such a state has occurred for each of the in-range objects.

When the covering determination is performed, next, the color and the like of each pixel of the virtual photograph is specified on the basis of the determination result of the covering determination, the chromatic information of the in-range object, and the like, and the two-dimensional data of the virtual photograph can be generated.

As described above, the virtual photograph can be generated on the basis of three-dimensional shape information, size information, and chromatic information of one or more objects in the virtual reality space, the position information, the orientation information, and the posture information of each object at the time of capturing, and position information, orientation information, and angle of view information of the virtual camera at the time of capturing, and the like.

All of these pieces of information are information included in the space data, and the space data is shared between the participant terminal 4 and the service providing server 3 in substantially real time. Therefore, in a case where the participant terminal 4 transmits operation information including operation information indicating a capturing operation to be described later to the service providing server 3, both the participant terminal 4 and the service providing server 3 can generate the virtual photograph.

In the following description, it is assumed that at least the participant terminal 4 generates the virtual photograph, and photograph information and the like, which will be described later, related to the virtual photograph are transmitted from the participant terminal 4 to the information processing apparatus 2. However, as described above, the service providing server 3 can also generate the virtual photograph. In a case where the service providing server 3 generates the virtual photograph, the photograph information and the like may be transmitted from the service providing server 3 to the information processing apparatus 2 instead of being transmitted from the participant terminal 4 to the information processing apparatus 2.

Note that, in a case where both the participant terminal 4 and the service providing server 3 generate the virtual photograph, a rule for generating a photograph ID to be described later may be a common rule between the participant terminal 4 and the service providing server 3.

A unique ID (hereinafter referred to as “photograph ID”) is assigned to the two-dimensional data of the virtual photograph by the participant terminal 4 or the service providing server 3. The participant terminal 4 may associate the two-dimensional data of the virtual photograph generated by itself with the photograph ID, and store the data in a storage unit (hereinafter referred to as a “participant terminal storage unit”), included in the participant terminal 4. In addition, in a case where the service providing server 3 does not generate the virtual photograph, the participant terminal 4 may associate the two-dimensional data of the virtual photograph generated by itself, the photograph ID, and the user ID of the participant who has participated in the virtual reality space and captured the virtual photograph using the participant terminal 4, and transmit them to the service providing server 3. When acquiring these pieces of information from the participant terminal 4, the service providing server 3 stores the two-dimensional data of the virtual photograph and the photograph ID in the service providing server storage unit in association with the user ID already stored in the service providing server storage unit.

In a case where the participant participates in the virtual reality space, for example, as an avatar using the participant terminal 4, when the participant operates the participant terminal 4 in order to capture a virtual photograph by using the virtual camera (hereinafter referred to as “capturing operation”), the participant terminal 4 generates the virtual photograph and gives a photograph ID to the generated virtual photograph. Furthermore, the participant terminal 4 transmits the camera information, the photograph information of the generated virtual photograph, and information of the in-range object (hereinafter referred to as “object information”) to the information processing apparatus 2.

The photograph information includes at least the photograph ID. Further, the photograph information may include two-dimensional data of the generated virtual photograph. Furthermore, the photograph information may include the capturing time of the virtual photograph.

The object information is information including at least three-dimensional shape information, size information, object ID, and position information at the time of capturing of each in-range object. Furthermore, the object information can also include the orientation information at the time of capturing, the posture information at the time of capturing, or metadata other than the object ID of each in-range object. The metadata other than the object ID may include, for example, the owner ID, sales information regarding sales of the object, and the like.

### Details of Information Processing Apparatus

Details of the information processing apparatus 2 will be described below. As illustrated in FIG. 1, the information processing apparatus 2 includes a communication unit 21, a calculation unit 22, and a storage unit 23.

The communication unit 21 communicates with the service providing server 3 and the participant terminal 4 via the network 5. Furthermore, for example, the communication unit 21 is a communication device capable of mobile communication by a communication method such as LTE, 3G, 4G, or 5G, and communicates with other devices such as the service providing server 3 and the participant terminal 4 connected to the network 5. Furthermore, the communication unit 21 may include a near field communication unit such as Bluetooth (registered trademark).

The calculation unit 22 controls the overall operation of the information processing apparatus 2. The calculation unit 22 includes a capturing information acquisition unit 221, an object information acquisition unit 222, a determination unit 223, a determination result acquisition unit 224, an association unit 225, a search key acquisition unit 226, a search result acquisition unit 227, a notification unit 228, and a display information generation unit 229. By the calculation unit 22 executing the information processing application, the respective functions of the capturing information acquisition unit 221, the object information acquisition unit 222, the determination unit 223, the determination result acquisition unit 224, the association unit 225, the search key acquisition unit 226, the search result acquisition unit 227, the notification unit 228, and the display information generation unit 229 are implemented by the calculation unit 22.

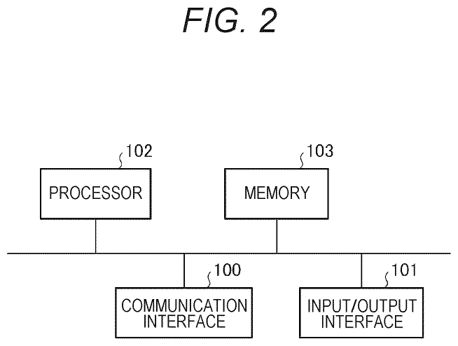

The storage unit 23 stores, for example, an information processing application and information used for arithmetic processing of the calculation unit 22. The storage unit 23 is a storage device included in a computer that functions as the information processing apparatus 2, and includes a storage such as a hard disk drive (HDD) or a solid state drive (SSD), or a memory 103 in FIG. 2. Note that the storage unit 23 only needs to be accessible by the information processing apparatus 2, and may be provided outside the information processing apparatus 2.

FIG. 2 is a block diagram illustrating hardware components that implement the functions of the information processing apparatus 2. For example, the information processing apparatus 2 includes a communication interface 100, an input/output interface 101, a processor 102, and a memory 103 as hardware components. The respective functions of the capturing information acquisition unit 221, the object information acquisition unit 222, the determination unit 223, the determination result acquisition unit 224, the association unit 225, the search key acquisition unit 226, the search result acquisition unit 227, the notification unit 228, the display information generation unit 229, a space selection screen display information acquisition unit 230, an event selection screen display information acquisition unit 231, a selection unit 232, an introduction screen display information acquisition unit 233, and a space data acquisition unit 234 included in the information processing apparatus 2 are implemented by execution of an information processing application in these hardware configurations.

The communication interface 100 outputs data received from the service providing server 3, the participant terminal 4, and the like via the network 5 to the processor 102, and transmits data generated by the processor 102 to the service providing server 3, the participant terminal 4, and the like via the network 5. The processor 102 reads and writes data from and to the storage unit 23 in FIG. 1 via the input/output interface 101.

A program constituting an information processing application for implementing the respective functions of the capturing information acquisition unit 221, the object information acquisition unit 222, the determination unit 223, the determination result acquisition unit 224, the association unit 225, the search key acquisition unit 226, the search result acquisition unit 227, the notification unit 228, the display information generation unit 229, the space selection screen display information acquisition unit 230, the event selection screen display information acquisition unit 231, the selection unit 232, the introduction screen display information acquisition unit 233, and the space data acquisition unit 234 included in the information processing apparatus 2 is stored in the storage unit 23.

The processor 102 reads the program stored in the storage unit 23 via the input/output interface 101, loads the program into the memory 103, and executes the program loaded into the memory 103. Thus, the processor 102 implements the respective functions of the capturing information acquisition unit 221, the object information acquisition unit 222, the determination unit 223, the determination result acquisition unit 224, the association unit 225, the search key acquisition unit 226, the search result acquisition unit 227, the notification unit 228, the display information generation unit 229, the space selection screen display information acquisition unit 230, the event selection screen display information acquisition unit 231, the selection unit 232, the introduction screen display information acquisition unit 233, and the space data acquisition unit 234. The memory 103 is, for example, a random access memory (RAM).

### Capturing Information Acquisition Unit

The capturing information acquisition unit 221 acquires capturing information including photograph information regarding a virtual photograph captured by a virtual camera used in a virtual reality space and space specifying information specifying the virtual reality space in which the virtual photograph is captured using the virtual camera among a plurality of virtual reality spaces different from each other.

The capturing information acquisition unit may acquire, as the space specifying information, a space data ID which is an ID unique to the three-dimensional data of the virtual reality space.

Furthermore, the capturing information acquisition unit 221 may acquire capturing information including camera information regarding the virtual camera used in the virtual reality space in addition to the photograph information and the space specifying information.

Hereinafter, it is assumed that the capturing information acquisition unit 221 acquires the photograph information, the space specifying information, and the camera information.

In a case where the participant participates in the virtual reality space as an avatar, for example, by using the participant terminal 4, when a capturing operation is performed in order to capture a virtual photograph by using a virtual camera held by the avatar, the participant terminal 4 generates a virtual photograph and gives a photograph ID to the generated virtual photograph, and further transmits the space specifying information (for example, space data ID) of the virtual reality space in which the virtual photograph is captured, the camera information, and the photograph information of the generated virtual photograph to the capturing information acquisition unit 221 of the information processing apparatus 2 as the capturing information.

Upon acquiring the capturing information from the participant terminal 4, the capturing information acquisition unit 221 outputs the acquired capturing information to the determination unit 223 and the association unit 225. In addition, the capturing information acquisition unit 221 stores the capturing information in the storage unit 23.

### Object Information Acquisition Unit

The object information acquisition unit 222 acquires object information regarding one or more objects (in-range objects) included in the capturing range of the virtual camera when the virtual photograph is captured among one or more objects arranged in the virtual reality space.

When generating the virtual photograph, the participant terminal 4 performs in-range object specification processing to specify the in-range object. The participant terminal 4 transmits the object information of the in-range object to the object information acquisition unit 222 of the information processing apparatus 2.

The object information acquisition unit 222 outputs the acquired object information of the in-range object to the determination unit 223. Furthermore, the acquired object information of the in-range object is stored in the storage unit 23.

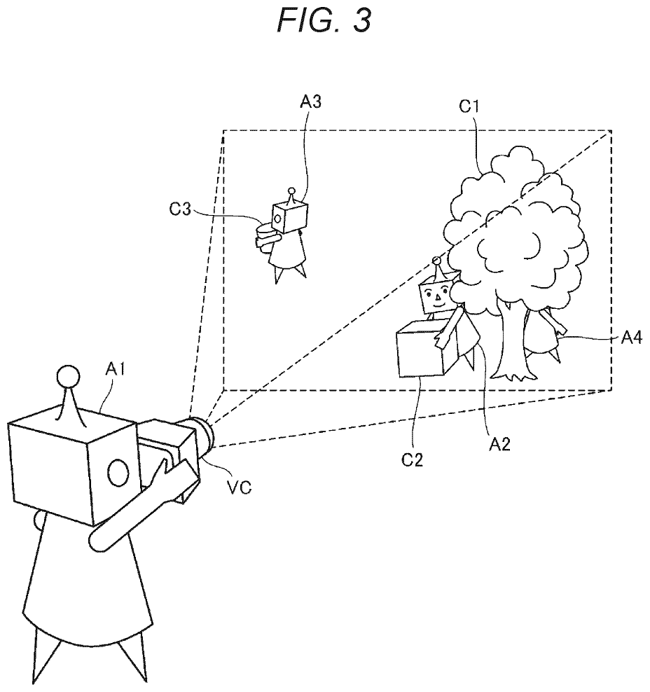

FIG. 3 is a conceptual view illustrating an example of virtual photographing. FIG. 3 illustrates four avatars A1 to A4, one tree object C1, two package objects C2 to C3, and a virtual camera VC arranged in virtual reality space. Note that one or more objects may be arranged in the virtual reality space in addition to the above-described objects illustrated in FIG. 3, but since these objects are arranged outside the capturing range, illustration is omitted.

In FIG. 3, the virtual camera VC is held by the avatar A1. Three avatars A2 to A4, one tree object C1, and two package objects C2 to C3 exist in the capturing range of the virtual camera VC (indicated by dotted lines in FIG. 3).

In the state illustrated in FIG. 3, as viewed from the position of the virtual camera, for example, the lower body portion of the avatar A2 is covered by the package object C2, and the most part including the upper body of the avatar A4 is covered by the tree object C1.

In this state, when the participant participating in the virtual reality space using the avatar A1 performs a capturing operation on the participant terminal 4 in order to capture the virtual photograph using the virtual camera VC, the participant terminal 4 generates the virtual photograph.

For example, the participant terminal 4 specifies the three avatars A2 to A4, the one tree object C1, and the two package objects C2 to C3 existing in the capturing range of the virtual camera VC as in-range objects through the above-described in-range object specification processing.

Furthermore, the participant terminal 4 determines that, for example, the lower body portion of the avatar A2 is covered by the package object C2 and the most part including the upper body of the avatar A4 is covered by the tree object C1 by the above-described covering determination processing, for example, and thus they are not shown in the virtual photograph.

Note that, as described above, the participant terminal 4 transmits the object information of the in-range objects, that is, the object information of the three avatars A2 to A4, the one tree object C1, and the two package objects C2 to C3 in the example illustrated in FIG. 3, to the object information acquisition unit 222 of the information processing apparatus 2.

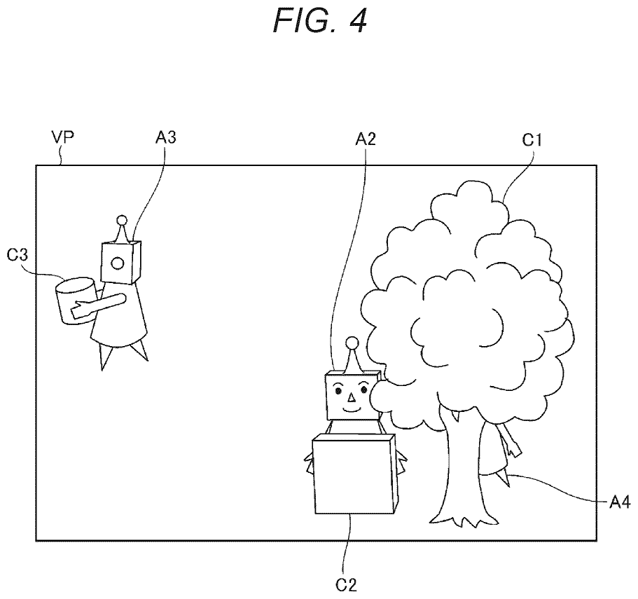

FIG. 4 is a screen diagram illustrating an example of a virtual photograph. FIG. 4 illustrates a virtual photograph VP generated by the capturing operation performed in the state of FIG. 3. In the virtual photograph VP, the three avatars A2 to A4, the one tree object C1, and the two package objects C2 to C3 are shown, but for example, the lower body portion of the avatar A2 and the most part including the upper body of the avatar A4 are not shown.

Note that, as described above, when generating the virtual photograph VP, the participant terminal 4 assigns a photograph ID to the generated virtual photograph VP, and further transmits the camera information and the photograph information of the generated virtual photograph VP to the capturing information acquisition unit 221 of the information processing apparatus 2 as capturing information.

### Determination Unit

Upon acquiring the capturing information from the capturing information acquisition unit 221 and acquiring the object information of the in-range objects from the object information acquisition unit 222, the determination unit 223 determines, for each of the in-range objects, whether or not to be the captured object shown in the virtual photograph on the basis of the camera information and the object information included in the capturing information (hereinafter referred to as “captured object determination”).

A condition (hereinafter referred to as “determination condition”) that the determination unit 223 determines which in-range object is determined to be the captured object in the captured object determination is set in advance and stored in, for example, the storage unit 23. The determination condition is determined by, for example, an organization or an individual that provides a service using the service providing server 3, and is set in advance by an operation on the information processing apparatus 2.

The determination unit 223 determines whether or not all of one or more in-range objects are captured objects.

In the captured object determination, by using the camera information and the object information of the in-range object, the determination unit 223 can calculate a state such as how large or what orientation or posture the in-range object that is a determination target is shown in the virtual photograph, or a state of covering such as how much the in-range object is covered, which portion of the in-range object is covered, or other capturing states. The determination unit 223 can perform the captured object determination by comparing the calculation result with the determination condition.

The content of the determination condition can be set in any manner.

For example, the determination condition may be such that, for the in-range object that is a determination target, if an area of a portion actually shown in the virtual photograph is equal to or more than a predetermined threshold with respect to an area that can be shown in the virtual photograph in a case where it is assumed that the in-range object is not covered at all, the in-range object is determined to be a captured object, and if the area is less than the predetermined threshold, the object is determined to be an in-range object that is not a captured object (hereinafter referred to as a “non-captured object”). The predetermined threshold is, for example, 50%.

Furthermore, for example, the determination condition may be such that, for the in-range object that is a determination target, if the ratio of an area that can be included in the virtual photograph to an area of the entire virtual photograph in a case where it is assumed that the in-range object is not covered at all is equal to or more than a predetermined threshold, the object is determined to be a captured object, and if the ratio is less than the predetermined threshold, the object is determined to be a non-captured object. The predetermined threshold is, for example, 0.1%.

Furthermore, for example, the determination condition may be such that, for the in-range object that is a determination target, if the ratio of an area shown in the virtual photograph to an area of the entire virtual photograph is equal to or more than a predetermined threshold, the object is determined to be a captured object, and if the ratio is less than the predetermined threshold, the object is determined to be a non-captured object. The predetermined threshold is, for example, 0.1%.

Furthermore, for example, the determination condition may be such that if a center point of the in-range object that is a determination target is shown in the virtual photograph, the object is determined to be a captured object, and if the center point is not in the virtual photograph, the object is determined to be a non-captured object, or if a ratio of the number of representative points that are within a certain distance from the position of the virtual camera and are shown in the photograph is equal to or more than a predetermined threshold among a plurality of representative points (which may also include the center point) set in advance on the in-range object, the object is determined to be a captured object, and if the ratio is less than the predetermined threshold, the object is determined to be a non-captured object. The predetermined threshold is, for example, 50%.

Furthermore, for example, the determination condition may be such that, in a case where the in-range object that is a determination target is an avatar, if the area of the head actually shown in the virtual photograph is equal to or more than a predetermined threshold with respect to the area of the head of the avatar that can be shown in the virtual photograph in a case where it is assumed that the avatar is not covered at all, the object is determined to be a captured object regardless of whether or not the other portion of the avatar is covered, and if the area is less than the predetermined threshold, the object is determined to be a non-captured object. The predetermined threshold is, for example, 50%.

Furthermore, for example, in a case where the in-range object that is a determination target is an avatar, the determination condition may be such that if an orientation of a front of the head of the avatar is within a predetermined angle range with respect to a straight line connecting the virtual camera and the head, the object is determined to be a captured object, and if the orientation is out of the predetermined angle range, the object is determined to be a non-captured object. The predetermined angle range is, for example, a range of −90° to +90° in a case where the angle of the orientation of the front of the head of the avatar in a state where the orientation of the front of the head of the avatar is oriented in a direction of the virtual camera is 0°.

In addition, the determination condition may be a condition in which two or more of the above-described examples are combined.

Furthermore, as described above, the content of the determination condition can be set in any manner, and is not limited to the above example.

The determination unit 223 adds a result of the captured object determination for the in-range object to the object information of each in-range object. For example, in a case where a certain in-range object is determined to be a captured object, the determination unit 223 adds “1” to the object information of the in-range object as a flag indicating the result of the captured object determination, and in a case where the object is determined to be a non-captured object, the determination unit 223 adds “0” to the object information of the in-range object as a flag indicating the result of the captured object determination.

Hereinafter, information in which at least information that can specify an in-range object (for example, the object ID) is associated with a result of the captured object determination is referred to as a “determination result”.

The determination unit 223 outputs the determination result to the determination result acquisition unit 224. For example, the determination unit 223 outputs the object information of each in-range object to which the determination result is given to the determination result acquisition unit 224 for all of the one or more in-range objects, to thereby output the determination result to the determination result acquisition unit 224. Alternatively, for example, the determination unit 223 may output the determination result to the determination result acquisition unit 224 by associating the determination result for each in-range object with the object ID of the in-range object for all of the one or more in-range objects and outputting them to the determination result acquisition unit 224.

Note that the determination unit 223 may be provided in either the participant terminal 4 or the service providing server 3 instead of the information processing apparatus 2. Details of this case will be described later.

### Determination Result Acquisition Unit

The determination result acquisition unit 224 acquires, on the basis of the camera information and the object information, a determination result of determining whether or not each of one or more objects (in-range objects) included in the capturing range is determined to be a captured object shown in the virtual photograph.

Upon acquiring the determination result from the determination unit 223, the determination result acquisition unit 224 outputs the acquired determination result to the association unit 225.

For example, the determination result acquisition unit 224 outputs the object information of each in-range object to which the determination result is given to the association unit 225 for all of the one or more in-range objects, thereby outputting the determination result to the association unit 225. Alternatively, for example, the determination result acquisition unit 224 may output the determination result to the association unit 225 by associating the determination result for each in-range object with the object ID of the in-range object for all of the one or more in-range objects and outputting them to the association unit 225.

### Association Unit

The association unit 225 associates the photograph information with the space specifying information.

Upon acquiring the capturing information from the capturing information acquisition unit 221, the association unit 225 associates at least the photograph ID included in the photograph information with the space specifying information, and stores the photograph ID and the space specifying information in the storage unit 23. The association unit may associate the space data ID as the space specifying information with the photograph ID and store them in the storage unit 23.

Furthermore, the association unit 225 may associate the object information with the photograph information on the basis of the determination result.

Upon acquiring the determination result from the determination result acquisition unit 224, the association unit 225 associates at least the object ID among information included in the object information of the in-range object that is an association target with the photograph ID included in the photograph information on the basis of the acquired determination result, and stores them in the storage unit 23.

As a mode of the association between the object information and the photograph information based on the determination result performed by the association unit 225, various modes can be employed.

For example, the association unit 225 may perform processing of associating the object information of the in-range object determined to be a captured object with the photograph information, and not associating the object information of the non-captured object, which is an in-range object determined not to be a captured object, with the photograph information.

Furthermore, for example, the association unit 225 may perform processing of associating the object information of the in-range object determined to be the captured object and the object information of the non-captured object, which is the in-range object determined not to be the captured object, with the photograph information in a distinguishing manner.

In this case, for example, the association unit 225 stores the object ID of the captured object and a flag “1” indicating the captured object in the storage unit 23 in association with the photograph ID, and stores the object ID of the non-captured object and a flag “0” indicating the non-captured object in the storage unit 23 in association with the photograph ID.

Furthermore, for example, the association unit 225 may perform, for a specific in-range object set in advance, processing of associating the object information of the in-range object with the photograph information regardless of whether the in-range object is determined to be a captured object or determined to be a non-captured object, or conversely, processing of not associating the object information of the in-range object with the photograph information regardless of whether the in-range object is determined to be a captured object or determined to be a non-captured object.

For the former, for example, any of one or more particular avatars, all avatars, one or more particular items, or all items may be preset as a particular in-range object whose object information is necessarily associated with the photograph information. For the latter, for example, an object as a background constituting the virtual reality space and an object similar to the background may be set in advance as a specific in-range object whose object information is not associated with the photograph information.

After the association processing is completed, the association unit 225 may transmit data (hereinafter referred to as “associated photograph information”) in which the space specifying information, the object information, and the photograph information are associated with each other to the participant terminal 4 that has transmitted the capturing information including the photograph information. In this case, the capturing information transmitted from the participant terminal 4 to the capturing information acquisition unit 221 is only required to include, for example, the user ID of the participant who participates in the virtual reality space as an avatar using the participant terminal 4 and has performed the capturing operation in order to capture the virtual photograph using the virtual camera. The association unit 225 can specify the user ID from the capturing information acquisition unit 221 via the storage unit 23 and the like.

Furthermore, the association unit 225 may transmit the associated photograph information to the service providing server 3 after the association processing is completed.

Note that since the participant terminal 4 has already specified the in-range object in the process of generating the virtual photograph, it can be interpreted that the photograph information of the virtual photograph and the object information are associated with each other at the time point when the participant terminal 4 generates the virtual photograph. Assuming this interpretation, the association processing by the association unit 225 can also be said to be processing of correcting the object information already associated with the photograph information on the basis of the determination result.

In other words, the association processing by the association unit 225 can include either or both of processing of newly associating the object information with photograph information that is not associated with any object information and processing of correcting the associated object information in the photograph information already associated with the object information.

As described above, the object also includes an avatar. Therefore, in a case where one or more avatars are included in the capturing range, the determination unit 223 performs the captured object determination for each of the in-range objects on the basis of the camera information included in the capturing information and the object information of the in-range object including the one or more avatars.

Then, the determination result acquisition unit 224 acquires the determination result of the captured object determination for each of one or more avatars as one or more objects (in-range objects) included in the capturing range, and the association unit 225 associates the object information regarding the avatar with the photograph information on the basis of the determination result.

In addition to the space specifying information or in addition to the space specifying information and the object information, the association unit 225 may associate the user specifying information specifying the user of the virtual reality space who has captured the virtual photograph using the virtual camera with the photograph information.

The user of the virtual reality space who has captured the virtual photograph using the virtual camera is, for example, a participant who participates in the virtual reality space as an avatar using the participant terminal 4 and has performed the capturing operation in order to capture the virtual photograph using the virtual camera. In the above case, the user specifying information is the user ID of the participant.

In this case, the capturing information transmitted from the participant terminal 4 to the capturing information acquisition unit 221 is only required to include, for example, the user ID of the participant who participates in the virtual reality space as an avatar using the participant terminal 4 and has performed the capturing operation in order to capture the virtual photograph using the virtual camera. The association unit 225 can specify the user ID from the capturing information acquisition unit 221 via the storage unit 23 and the like.

Alternatively, in addition to the space specifying information or in addition to the space specifying information and the object information, the association unit 225 may associate the event information related to an event held at the time of capturing the virtual photograph in the virtual reality space in which the virtual photograph is captured using the virtual camera with the photograph information.

In this case, the capturing information transmitted from the participant terminal 4 to the capturing information acquisition unit 221 is only required to include, for example, event information (event ID, organizer ID, or both IDs) related to the event held at the time of capturing the virtual photograph in the virtual reality space in which the participant participates using the participant terminal 4.

Alternatively, in a case where a plurality of events is held in one virtual reality space at the time of capturing the virtual photograph, it is only required to include at least event information related to an event in which the avatar of the participant participates at the time of capturing the virtual photograph. In a case where a plurality of events is held in one virtual reality space at the time of capturing the virtual photograph, each of the plurality of events is usually held at different positions from each other in the virtual reality space. Therefore, the event in which the avatar of the participant is participating can be specified, for example, from position coordinates indicating a place where the event is held in the virtual reality space and a date and time of the event (a date and a time slot when the event is held), and position coordinates indicating a place where the avatar of the participant who has captured the virtual photograph is present and a capturing date and time.

Furthermore, the association unit 225 may further associate the event information with the photograph information by including event information related to a related event having a specific relationship with an event held at the time of capturing the virtual photograph in the virtual reality space in which the virtual photograph is captured using the virtual camera.

A plurality of events having a specific relationship with each other can be included in one related event group as related events having a specific relationship with each other and stored in the service providing server storage unit. The information processing apparatus 2 can acquire information indicating a related event group from the service providing server storage unit in advance and store the information in the storage unit 23.

In this case, upon acquiring the capturing information from the capturing information acquisition unit 221, for example, the association unit 225 accesses the storage unit 23 to search whether there is a related event group including an event held at the time of capturing of the virtual photograph indicated by the photograph information acquired this time, and in a case where the related event group exists, the association unit 225 associates event information (for example, an event ID) related to one or more other related events included in the related event group with the photograph information of the virtual photograph.

On the other hand, the information processing apparatus 2 may not acquire the information indicating the related event group in advance from the service providing server storage unit. In this case, instead, it is assumed that event information of an event in the service provided by the service providing server 3 is acquired in advance and stored in the storage unit 23.

Upon acquiring the capturing information from the capturing information acquisition unit 221, the association unit 225 first acquires the above-described specific relationship description information, which is information describing the specific relationship, from the storage unit 23. Then, the association unit 225 searches for a related event having a specific relationship with the event related to the event held at the time of capturing the virtual photograph indicated by the photograph information acquired this time with reference to the specific relationship description information, and in a case where there are one or more related events, the association unit 225 associates the event information with the photograph information by including event information related to these related events in the event information. When such processing is performed every time the information processing apparatus 2 acquires the capturing information from the capturing information acquisition unit 221, as a result, the related event group is stored in the storage unit 23 in a mode associated with one piece of photograph information. However, since the above processing is performed only in a case where the virtual photograph is captured in the virtual reality space during the event, the related event group stored in the storage unit 23 is usually only a part of the related event group stored in the service providing server storage unit.

In a case where the object information and the photograph information are associated with each other, the association unit 225 may associate the sales information related to sales of the object corresponding to the object information with the photograph information in addition to the object information or as the object information.

As described above, the sales information is stored in the service providing server storage unit of the service providing server 3 in association with information that can specify an object such as an object ID. For example, the association unit 225 accesses the service providing server 3 and transmits the object ID of an in-range object to be an acquisition target of the sales information as a search key, and thereby the sales information of the in-range object stored in the service providing server storage unit can be acquired as a search result from the service providing server 3.

Furthermore, as described above, the object information may include the sales information. In this case, the object information transmitted from the participant terminal 4 to the object information acquisition unit 222 is only required to include, for example, the sales information of the object. The association unit 225 can acquire the sales information of the in-range object from the object information acquisition unit 222 via the storage unit 23 and the like.

In a case where the object information and the photograph information are associated with each other, the association unit 225 may associate search possibility information indicating possibility of search based on metadata including the object information associated with the photograph information with the photograph information for each object.

In particular, in a case where the two-dimensional data of the virtual photograph is included in the photograph information, the object information associated with the photograph information, in other words, the object information included in the associated photograph information can be said to be metadata of the photograph information.

Examples of the metadata of the photograph information include the user ID, the space data ID, the sales information, and the like described above. The space data ID and the user ID of the space creator among user IDs can be associated with the photograph information, but are metadata other than the object information. In addition, although the photograph information may include the time when the virtual photograph is captured, the time can also be referred to as metadata of the photograph information. The metadata associated with the photograph information in this manner may include metadata other than the object information.

In a case where a considerable number of pieces of associated photograph information are stored in the storage unit 23 of the information processing apparatus 2, as described later, the information processing apparatus 2 can provide the user with a service of searching for the photograph information using any of the pieces of metadata associated with the photograph information as a search key. In this case, it is assumed that the photograph information includes the photograph ID and two-dimensional data of the virtual photograph.

However, among the in-range objects, the owner or the like of the in-range object may not want another person to acquire the photograph information of a virtual photograph in which the in-range object is captured by search. For example, in a case where the in-range object is an avatar, when photograph information that is not intended by a participant participating in the virtual reality space by using the avatar is acquired by another person, the participant may feel that privacy is violated.

Accordingly, the service providing server 3 can have a function for registering search possibility information indicating whether or not an object can be retrieved in association with information that allows the owner or the like of the object to specify the object such as an object ID.

For example, a participant planning to participate in the virtual reality space using an avatar registers the search possibility information in the service providing server 3 in association with the object ID of the avatar owned by himself or herself at the time of registration as a user of the service, or the like. For example, the service providing server 3 sets a flag “1” in a case where the search can be performed and sets a flag “0” in a case where the search cannot be performed, and stores the search possibility information in the service providing server storage unit in association with the object ID of the avatar owned by the user.

The association unit 225 accesses the service providing server 3 and transmits the object ID of an in-range object to be an acquisition target of the search possibility information as a search key, and thereby the search possibility information of the in-range object stored in the service providing server storage unit can be acquired as a search result from the service providing server 3.

Furthermore, the association unit 225 may determine the search possibility from the environment in which the virtual photograph is captured, and generate the search possibility information. For example, in the service providing server storage unit of the service providing server 3, search possibility information such as a flag indicating search possibility can be stored in advance in association with each space data ID.

### Search Key Acquisition Unit and Search Result Acquisition Unit

The information processing apparatus 2 may further include the search key acquisition unit 226 that acquires object information as a search key for searching for photograph information, and the search result acquisition unit 227 that acquires photograph information retrieved on the basis of the object information.

In a case where a considerable number of pieces of associated photograph information are stored in the storage unit 23 of the information processing apparatus 2, the information processing apparatus 2 can provide the user with a service (hereinafter referred to as a “search service”) for searching for photograph information using, for example, an object ID, an owner ID, or the like, among the object information associated with the photograph information, as a search key. In this case, it is assumed that the photograph information includes the photograph ID and two-dimensional data of the virtual photograph.

The user of the search service is, for example, a user registered as a user of a service using the virtual reality space provided by the service providing server 3.

When the user of the search service accesses the information processing apparatus 2 by operating the terminal (hereinafter referred to as a “search terminal”) used by himself or herself and then inputs and transmits a search key through the search terminal, the search key acquisition unit 226 of the information processing apparatus 2 acquires the search key transmitted from the search terminal. Note that the search terminal may be the terminal used as the participant terminal 4.

Upon acquiring the search key, the search key acquisition unit 226 outputs the acquired search key to the search result acquisition unit 227.

Upon acquiring the search key from the search key acquisition unit 226, the search result acquisition unit 227 accesses the storage unit 23 and acquires, as a search result, photograph information associated with object information corresponding to the search key or the photograph information and object information associated with the photograph information (associated photograph information). In addition, in a case where the photograph information associated with the object information corresponding to the search key is not stored in the storage unit 23, the search key acquisition unit 226 acquires, as a search result, information indicating that the photograph information associated with the object information corresponding to the search key has not been acquired.

Upon acquiring the search result, the search result acquisition unit 227 transmits the acquired search result to the search terminal.

The information processing apparatus 2 may include the search key acquisition unit 226 that acquires space specifying information as a search key for searching for photograph information, and the search result acquisition unit 227 that acquires photograph information retrieved on the basis of the space specifying information.

The information processing apparatus 2 can provide the user with a search service for searching for photograph information using the space specifying information, that is, the space data ID, among metadata of object information associated with the photograph information, as a search key. Also in this case, it is assumed that the photograph information includes the photograph ID and the two-dimensional data of the virtual photograph.

Processing performed by the search key acquisition unit 226 and the search result acquisition unit 227 is similar to that in the case where the object information is used as the search key as described above, and thus description thereof is omitted.

Note that the search key acquisition unit 226 may be able to acquire only the object information, may be able to acquire only the space specifying information, or may be able to acquire both of them as the search key. Furthermore, the association with the photograph information by the association unit 225 can also be performed with, for example, the event information or the like. Therefore, the search key acquisition unit 226 may acquire metadata of the photograph information other than the object information and the space specifying information as the search key. In either case, the search result acquisition unit 227 acquires a search result based on the search key acquired from the search key acquisition unit 226.

The information processing apparatus 2 includes the search key acquisition unit 226 that acquires object information as a search key for searching for photograph information, and the search result acquisition unit 227 that acquires photograph information retrieved on the basis of the object information and associated with search possibility information indicating that search is possible.

In a case where the association unit 225 associates the search possibility information with the photograph information for each object as described above, and the search possibility information is stored in the storage unit 23 in association with the photograph information, even if the photograph information associated with the object information corresponding to the search key is retrieved, the search result acquisition unit 227 does not acquire the retrieved photograph information but instead acquires, for example, information indicating that the photograph information associated with the object information corresponding to the search key has not been acquired as a search result in a case where the search possibility information associated with the photograph information indicates that the search is not possible (for example, the flag “0”).

On the other hand, in a case where the photograph information associated with the object information corresponding to the search key is retrieved, and the search possibility information associated with the photograph information indicates that search is possible (for example, the flag “1”), the search result acquisition unit 227 acquires the retrieved photograph information as a search result.

In any case, when acquiring the search result, the search result acquisition unit 227 transmits the acquired search result to the search terminal.

Note that the search service by the information processing apparatus 2 can be provided as long as the photograph information is associated with some object information. That is, the associated photograph information that is a target of the search service does not necessarily need to be associated on the basis of the result of the captured object determination.

### Notification Unit

The information processing apparatus 2 may further include the notification unit 228 that notifies a notification destination specified according to a predetermined notification condition of photograph information when object information of an in-range object determined to be a captured object is associated with the photograph information.

In a case where the information processing apparatus 2 includes the notification unit 228, the association unit 225 performs processing of associating the object information with the photograph information, and then outputs the associated photograph information to the notification unit 228. Further, in this case, the metadata included in the associated photograph information includes user IDs of various users.

After the notification unit 228 acquires the associated photograph information, a notification condition defining who is to be notified of the acquired associated photograph information is set in advance and stored in, for example, the storage unit 23. The notification condition is information describing which notification destination is to be notified of the photograph information according to the object information of the captured object associated with the photograph information, the space specifying information (space data ID) associated with the photograph information, event information associated with the photograph information, or the like. The notification condition is determined by, for example, an organization or an individual that provides a service using the service providing server 3, and is set in advance by an operation on the information processing apparatus 2.

Upon acquiring the associated photograph information from the association unit 225, the notification unit 228 acquires the notification condition from the storage unit 23 and notifies the notification destination corresponding to the notification condition of the photograph information or the associated photograph information.

In a case where the metadata included in the associated photograph information includes information (for example, an e-mail address, an in-application notification of a service application, or the like) indicating the notification means to the notification destination, the notification unit 228 uses the indicated notification means to notify the notification destination of the photograph information or the associated photograph information.

When the metadata included in the associated photograph information does not include the information indicating the notification means to the notification destination, the notification unit 228 accesses the service providing server 3 and acquires the information indicating the notification means. The notification destination is usually a user registered in a service provided by the service providing server 3, and as described above, the information indicating the notification means to the user is stored in the service providing server storage unit in association with the user ID. Therefore, when the metadata included in the associated photograph information does not include the information indicating the notification means to the notification destination, the notification unit 228 accesses the service providing server 3, and acquires the information indicating the notification means from the service providing server 3 by transmitting the user ID.

For example, the notification unit 228 notifies the notification destination of the photograph information by using the owner of the captured object, the creator of the captured object, or the seller of the captured object specified according to the notification condition as the notification destination.

Furthermore, for example, the notification unit 228 may notify the notification destination of the photograph information by using, as the notification destination, the space creator of the virtual reality space in which the virtual photograph is captured, the event organizer holding an event using the virtual reality space when the virtual photograph is captured in the virtual reality space, or the space observer of the virtual reality space in which the virtual photograph is captured, which are specified according to the notification condition.

In the notification condition, only one type of notification destination may be described, or a plurality of types of notification destinations may be described.

Note that the notification service by the information processing apparatus 2 can be provided as long as the photograph information is associated with some object information. That is, the associated photograph information that is a target for the notification service is not necessarily associated on the basis of the result of the captured object determination.

### Display Information Generation Unit

The information processing apparatus 2 may further include the display information generation unit 229 that generates display information for displaying, when the captured object is designated by an operation of designating the captured object in the virtual photograph performed on the virtual photograph arranged in the virtual reality space, object information of a designated captured object.

Hereinafter, it is assumed that the storage unit 23 stores object information similar to the object information of the captured object stored in the service providing server storage unit of the service providing server 3.

As described above, the entity of the virtual photograph is two-dimensional data, but may be one of objects. That is, the two-dimensional data of the virtual photograph can be handled as three-dimensional data having no thickness. For example, the avatar in the virtual reality space can change its state by holding, moving, and the like of the virtual photograph similar to other objects.

For example, for an in-range object shown in a virtual photograph, information regarding which portion in the photograph corresponds to which in-range object (hereinafter referred to as “in-photograph position information”) can be given as metadata associated with photograph information of the virtual photograph.

Such information can be acquired in the process of generating the virtual photograph. For example, this is because, when the final color of the pixel or the like is specified, the color of the pixel or the like is specified by using a result of determining which pixel is the color of the in-range object.

The in-photograph position information is information in which the position of each pixel of the virtual photograph is associated with the object ID of the in-range object corresponding to the pixel, and is managed in association with the photograph ID of the virtual photograph. The in-photograph position information is a kind of metadata of two-dimensional data of the virtual photograph.

The participant first performs an appropriate operation on the participant terminal 4, designates a desired virtual photograph from one or more virtual photographs stored as the associated photograph information in the storage unit 23 of the information processing apparatus 2, acquires the virtual photograph, and arranges the virtual photograph in the virtual reality space. In a case where a virtual photograph is stored as the associated photograph information in the participant terminal storage unit of the participant terminal 4 or the service providing server storage unit of the service providing server 3, the participant can perform an appropriate operation on the participant terminal 4, designate a desired virtual photograph from these storage units, and arrange the desired virtual photograph in the virtual reality space.

For example, using the participant terminal 4, the participant can view one or more virtual photographs captured by himself or herself by using an album object imitating a real album, and can designate one virtual photograph from the virtual photographs and arrange the virtual photograph in the virtual reality space. Furthermore, for example, the participant can operate the participant terminal 4 to arrange the virtual photograph acquired using the above-described search service in the virtual reality space.

When the virtual photograph is designated by operating the participant terminal 4, the participant terminal 4 accesses the information processing apparatus 2 and transmits the photograph ID of the designated virtual photograph, and thereby the associated photograph information of the designated virtual photograph stored in the storage unit 23 can be acquired. Upon acquiring the virtual photograph as the associated photograph information, the participant terminal 4 arranges the virtual photograph in the virtual reality space.

Thereafter, the participant can designate any of the captured objects in the virtual photograph with respect to the virtual photograph arranged in the virtual reality space by operating the participant terminal 4.

An operation for designation (hereinafter referred to as “designation operation”) is an operation of pressing one point on the captured object shown in the virtual photograph with an avatar's finger or the like, an operation of pressing one point on the captured object shown in the virtual photograph with a pointer for designation arranged in the virtual reality space, or the like. The designation operation may be any operation as long as one point on the captured object shown in the virtual photograph can be designated.

When the avatar's finger or the like moves on the virtual photograph, the participant terminal 4 may specify the position on the virtual photograph where the avatar's finger or the like exists, determine the captured object existing at the specified position on the basis of the in-photograph position information and the information of whether or not the in-range object associated with the photograph information is the captured object, and display a frame line surrounding the outline of the captured object shown in the virtual photograph. In a case where the specified position corresponds to an object or the like other than the captured object, the participant terminal 4 does not display a frame line surrounding the outline.

In a case where the participant terminal 4 displays such a frame line, the participant can more easily know which captured object can be designated at the current position of the avatar's finger or the like, as compared with a case where the frame line is not displayed.

Note that the virtual photograph may be displayable outside the virtual reality space. For example, the virtual photograph may be displayed on a web browser normally displayed on a screen of a terminal used by the user such as the participant terminal 4. The designation operation in this case may be an operation of clicking one point on the captured object shown in the virtual photograph with a mouse or an operation of tapping one point on the captured object shown in the virtual photograph on a touch panel.

When one point on the captured object shown in the virtual photograph is designated, the participant terminal 4 specifies coordinates of the designated one point on the virtual photograph, in other words, the position of a pixel, and specifies the object ID of the designated captured object on the basis of the specified position of the pixel and the in-photograph position information.

Upon specifying the object ID of the designated captured object, the participant terminal 4 transmits the specified object ID to the display information generation unit 229 of the information processing apparatus 2. The display information generation unit 229 acquires the object information associated with the object ID from the storage unit 23 as a search result.

Note that the object information in this case includes three-dimensional data such as three-dimensional shape information or size information of the captured object, or metadata such as an object ID, an owner ID, or sales information regarding sales of the object, and does not include information specific to the time of capturing such as position information at the time of capturing, orientation information at the time of capturing, or posture information at the time of capturing.

However, in a case where the information specific to the time of capturing is stored in the storage unit 23 in association with the photograph ID, the object information may include information specific to capturing. In this case, the participant terminal 4 transmits the photograph ID to the display information generation unit 229 of the information processing apparatus 2 in addition to the object ID of the designated captured object.

Upon acquiring the object information, the display information generation unit 229 generates display information for displaying the object information of the designated captured object. Then, the display information generation unit 229 transmits the generated display information to the participant terminal 4. Upon acquiring the display information, the participant terminal 4 displays the object information on the basis of the display information.

As described above, the association unit 225 associates at least the object ID among the information included in the object information of the in-range object with the photograph ID included in the photograph information, and stores the associated information in the storage unit 23. Therefore, the object information included in the associated photograph information may be only the object ID or may have a relatively small amount of information. On the other hand, the information processing apparatus 2 can provide more detailed information to the participants by acquiring detailed object information stored in the storage unit 23, for example.

When the displayed object information is selected, the participant terminal 4 may display an object purchase screen or display a favorite registration screen or the like.

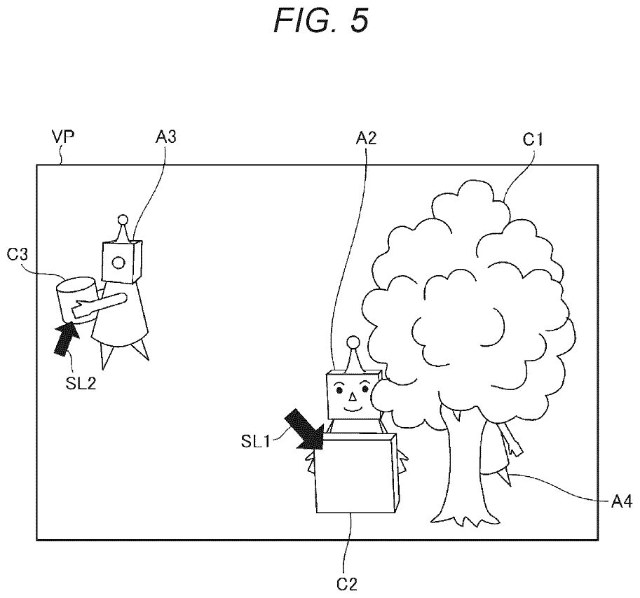

FIG. 5 is a screen view illustrating an example of object designation in the virtual photograph.

Similarly to FIG. 4, FIG. 5 illustrates the virtual photograph VP generated by the capturing operation performed in the state of FIG. 3. In the virtual photograph VP, the three avatars A2 to A4, the one tree object C1, and the two package objects C2 to C3 are shown, but for example, the lower body portion of the avatar A2 and the most part including the upper body of the avatar A4 are not shown.

Here, it is assumed that, among the in-range objects shown in the virtual photograph VP, only the avatar A4 is a non-captured object, and all the other in-range objects are captured objects.

In FIG. 5, in addition to the in-range object, pointers SL1 to SL2 for designation for designating the captured object are illustrated. The pointers SL1 to SL2 for designation are one type of objects arranged in the virtual reality space, but are not in-range objects shown in the virtual photograph VP. Furthermore, the participant can move the pointers SL1 to SL2 for designation to any position on the virtual photograph VP by operating the participant terminal 4, and can designate one point on the captured object shown in the virtual photograph VP using the pointers SL1 to SL2 for designation.

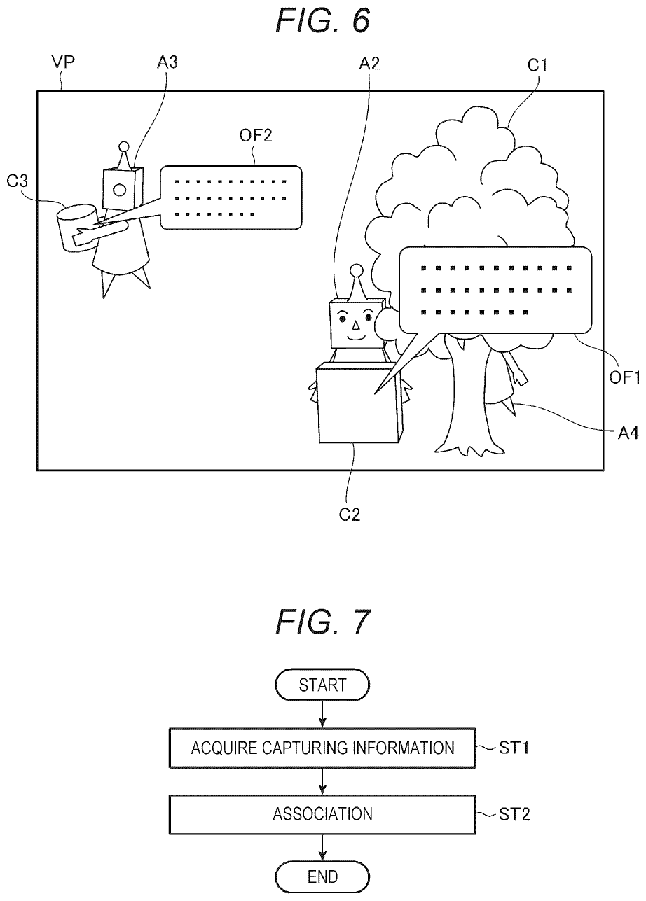

FIG. 6 is a screen diagram illustrating a display example of objects and object information in a virtual photograph. In FIG. 5, it is assumed that the participant operates the participant terminal 4 to designate one point on the package object C2 using the pointer SL1 for designation and designate one point on the package object C3 using the pointer SL2 for designation.

In this case, as illustrated in FIG. 6, a balloon OF1 is displayed for the package object C2 shown in the virtual photograph VP, and a balloon OF2 is displayed for the package object C3 shown in the virtual photograph VP. The balloons OF1 to OF2 are also one type of objects arranged in the virtual reality space, but are not in-range objects shown in the virtual photograph VP. The balloons OF1 to OF2 may be objects that can be viewed by participants other than the participant who has performed the operation for displaying these balloons, or may be objects that cannot be viewed by these participants.

The object information of the package object C2 is displayed inside the balloon OF1, and the object information of the package object C3 is displayed inside the balloon OF2.

The information processing apparatus 2 may include the display information generation unit 229 that generates display information for displaying, when the captured object is designated by an operation of designating the captured object in the virtual photograph performed on the virtual photograph arranged in the virtual reality space, the object information of the designated captured object, and displaying, when the non-captured object is designated by an operation of designating the non-captured object, the object information of the designated non-captured object.

Furthermore, the non-captured object may be entirely or partially shown in the virtual photograph, or may not be shown at all.

In a case where the non-captured object is shown in the virtual photograph in some manner, similarly to the case of the captured object described above, the participant can designate the non-captured object on the virtual photograph by operating the participant terminal 4 and cause the object information of the non-captured object to be displayed.

On the other hand, in order to make it possible to designate a non-captured object even in a case where the non-captured object is not shown in the virtual photograph at all, for example, the participant terminal 4 can display, on the basis of the object information of one or more non-captured objects included in the associated photograph information, a list indicating at least the object IDs of the non-captured objects. Furthermore, in a case where an object name is included in the object information of the non-captured object included in the associated photograph information, the participant terminal 4 can display a list indicating the object name of one or more non-captured objects instead of the object ID or in addition to the object ID.

The participant terminal 4 may display the list in the virtual reality space or may display the list outside the virtual reality space. In addition, the participant terminal 4 may add the object ID or the object name of the captured object to the list and display the list.

The participant operates the participant terminal 4 to cause the list to be displayed and select a non-captured object in the list, so that the participant terminal 4 can transmit the object ID of the selected non-captured object to the display information generation unit 229 and display the object information of the selected non-captured object through processing similar to the above. Furthermore, in a case where the participant terminal 4 displays the list by adding the object ID or the object name of the captured object, the participant can similarly cause the object information of the selected captured object to be displayed by selecting the captured object in the list.

Furthermore, in a case where a position in the virtual photograph that can be shown in the virtual photograph when it is assumed that an in-range object is not covered at all can be specified for the in-range object not shown in the virtual photograph at all when the virtual photograph is generated by the participant terminal 4, the position can be included in the object information associated with the photograph information.

In this case, for example, when the participant operates the participant terminal 4 to designate a desired range on the virtual photograph, the participant terminal 4 can also specify an object ID of a non-captured object that is partially or entirely included in the range but is not shown in the virtual photograph.

Then, the participant terminal 4 transmits the object ID of the specified non-captured object to the display information generation unit 229, and can display the object information of the specified non-captured object through processing similar to the above.

Note that the service of object information display by the information processing apparatus 2 can be provided as long as the photograph information of the virtual photograph is associated with some object information. That is, the associated photograph information of the virtual photograph that is a target of the object information display service is not necessarily associated based on the result of the captured object determination.

### Space Selection Screen Display Information Acquisition Unit

The information processing apparatus 2 may further include the space selection screen display information acquisition unit 230 that acquires space selection screen display information for displaying a space selection screen on which one virtual reality space for participation can be selected from among a plurality of virtual reality spaces different from each other.

On the space selection screen, space recognition information that allows recognizing each of a plurality of virtual reality spaces different from each other is displayed, and a virtual photograph associated with space specifying information of the virtual reality space is displayed for each piece of space recognition information. Then, the user can participate in a space with his or her own avatar by selecting the space in which the user wants to participate. The space recognition information is information for the user who has viewed the information to easily recognize the virtual reality space, and is, for example, a thumbnail image of the virtual reality space corresponding to the space recognition information, a name of the virtual reality space, a name of a space creator who has created space data of the virtual reality space and uploaded the space data to the service providing server 3, and the like.

For example, when the user of the service accesses the service providing server 3 from the participant terminal 4, the space selection screen can be displayed on the display of the participant terminal 4 first or through a predetermined operation by the user.

The space selection screen is a screen displayed for the user to select a virtual reality space in which the user participates from among a plurality of mutually different virtual reality spaces.

On the space selection screen, a plurality of pieces of space recognition information different from each other are arranged in, for example, n rows and m columns (n and m are any integers) and displayed. For example, one piece of space recognition information is displayed in a mode in which the name of the virtual reality space is arranged at a lower part of the thumbnail image and the name of the space creator is arranged at a lower part thereof. Then, one or more virtual photographs captured in the virtual reality space corresponding to the space recognition information are displayed side by side in the periphery (for example, a lower part of the name of the space creator) of each space recognition information. These one or more virtual photographs include at least a virtual photograph that is not a virtual photograph created by the space creator or the like (for example, a thumbnail image or a virtual photograph captured by the space creator as a participant). That is, at least one or more virtual photographs captured in the virtual reality space by one or more participants who are participants other than the space creator of the virtual reality space corresponding to the space recognition information are displayed side by side around one piece of space recognition information.

For example, upon being accessed from the participant terminal 4, the service providing server 3 transmits space specifying information (for example, space data IDs) of a plurality of virtual reality spaces to be displayed on the space selection screen, the space recognition information, and the user ID of the user who has accessed from the participant terminal 4 to the information processing apparatus 2. Upon acquiring the space specifying information, the space recognition information, and the user IDs of the plurality of virtual reality spaces from the service providing server 3, the information processing apparatus 2 extracts a virtual photograph associated with the space specifying information from the storage unit 23, and generates the space selection screen display information according to a predetermined format. Upon acquiring the generated space selection screen display information, the space selection screen display information acquisition unit transmits the acquired space selection screen display information to the participant terminal 4 specified from the user ID. Upon acquiring the space selection screen display information from the information processing apparatus 2, the participant terminal 4 displays the space selection screen on the display.

The user determines the virtual reality space in which the user participates while referring to the plurality of pieces of space recognition information and the virtual photographs displayed on the space selection screen, and performs a selection operation to select the space recognition information of the virtual reality space by, for example, a click operation. When the selection operation is performed in the participant terminal 4, the participant terminal 4 transmits the space specifying information of the selected virtual reality space to the service providing server 3, and in response to this, space data of the virtual reality space specified by the space specifying information is transmitted from the service providing server 3 to the participant terminal 4. Upon acquiring the space data from the service providing server 3, the participant terminal 4 displays the virtual reality space represented by the space data on the display.

In the above description, an example has been described in which the space data is immediately transmitted to the participant terminal 4 when the user performs the selection operation of selecting one piece of space recognition information among the plurality of pieces of space recognition information, but instead of this, when the selection operation is performed, first, a description screen in detail (hereinafter referred to as a “detailed description screen”) of only the selected virtual reality space may be displayed. In addition to displaying the space recognition information and one or more virtual photographs, the detailed description screen also displays a detailed description of the virtual reality space, such as a description of what content the selected virtual reality space has, the size of the space data, the release date, and whether or not the virtual reality space can be used in an event.

Here, the detailed description screen is also included in the space selection screen.

Furthermore, in the above description, an example has been described in which the virtual photograph is displayed around each of the plurality of pieces of displayed space recognition information on the space selection screen. Alternatively, in a state where the plurality of pieces of space recognition information is displayed on the space selection screen, the virtual photograph may not be displayed, and the virtual photograph may be displayed only on the detailed description screen after (the virtual reality space corresponding to) one piece of space recognition information is selected from the space selection screen in this state.

### Event Selection Screen Display Information Acquisition Unit

The information processing apparatus 2 may further include the event selection screen display information acquisition unit 231 that acquires event selection screen display information for displaying an event selection screen from which one event for participation can be selected among a plurality of events different from each other.

The event selection screen displays event recognition information that allows recognizing each of a plurality of different events, and displays a virtual photograph associated with the event information for each piece of the event recognition information. Then, the user can participate in the space in which the event is held with his or her own avatar by selecting an event that he/she wants to participate in. The event recognition information is information for the user who has viewed the information to easily recognize the event content, and is, for example, a thumbnail image of the event corresponding to the event recognition information, a name of the event, a name of an event organizer of the event, or the like.

For example, when the user of the service accesses the service providing server 3 from the participant terminal 4, the event selection screen can be displayed on the display of the participant terminal 4 first or through a predetermined operation by the user.

The event selection screen is a screen displayed for the user to select an event in which the user participates from among a plurality of events different from each other.

On the event selection screen, a plurality of pieces of event recognition information different from each other is arranged in, for example, n rows and m columns (n and m are any integers) and displayed. For example, one piece of event recognition information is displayed in a mode in which the name of the event is arranged at a lower part of the thumbnail image and the name of the event organizer is arranged at a lower part thereof. Then, one or more virtual photographs captured in the virtual reality space when the event corresponding to the event recognition information is held are displayed side by side in the vicinity of each piece of the event recognition information (for example, a lower part of the name of the event organizer).

For example, upon being accessed from the participant terminal 4, the service providing server 3 transmits event information (for example, event IDs) of a plurality of events to be displayed on the event selection screen, the event recognition information, and the user ID of the user who has accessed from the participant terminal 4 to the information processing apparatus 2. Upon acquiring the event information, the event recognition information, and the user ID of the plurality of events from the service providing server 3, the information processing apparatus 2 extracts a virtual photograph associated with the event information from the storage unit 23, and generates the event selection screen display information according to a predetermined format. Upon acquiring the generated event selection screen display information, the event selection screen display information acquisition unit transmits the acquired event selection screen display information to the participant terminal 4 specified from the user ID. Upon acquiring the event selection screen display information from the information processing apparatus 2, the participant terminal 4 displays an event selection screen on the display.

The user determines an event in which the user participates while referring to the plurality of pieces of event recognition information and the virtual photograph displayed on the event selection screen, and performs a selection operation to select the event recognition information of the event by, for example, a click operation. When the selection operation is performed in the participant terminal 4, the participant terminal 4 transmits the selected event and the space specifying information of the virtual reality space in which the event is held to the service providing server 3, and in response to this, the service providing server 3 transmits the space data of the virtual reality space specified by the space specifying information to the participant terminal 4. The space data also includes data for displaying an event being held. Upon acquiring the space data from the service providing server 3, the participant terminal 4 displays the virtual reality space represented by the space data on the display.

In the above description, an example has been described in which the space data is immediately transmitted to the participant terminal 4 when the user performs the selection operation of selecting one piece of event recognition information among the plurality of pieces of event recognition information, but instead of this, when the selection operation is performed, first, a description screen in detail (hereinafter referred to as a “detailed description screen”) of only the selected event may be displayed. Also on the detailed description screen, in addition to displaying the event recognition information and one or more virtual photographs, a detailed description of the event, such as a description of what content the selected event has, and the date and time of the event, is displayed.

Here, the detailed description screen is also included in the event selection screen.

Furthermore, in the above description, an example has been described in which the virtual photograph is displayed around each of the plurality of pieces of displayed event recognition information on the event selection screen. Alternatively, in a state where the plurality of pieces of event recognition information is displayed on the event selection screen, the virtual photograph may not be displayed, and the virtual photograph may be displayed only on the detailed description screen after (the event corresponding to) one piece of event recognition information is selected from the event selection screen in this state.

### Selection Unit

The information processing apparatus 2 may further include a selection unit that selects the virtual photograph displayed on the space selection screen among the plurality of virtual photographs associated with the space specifying information of the virtual reality space on the basis of the selection condition.

In a case where a plurality of virtual photographs is stored in the storage unit 23 in association with the space specifying information of one virtual reality space, it may be impossible to display all the virtual photographs around the space recognition information of the virtual reality space on the space selection screen. Furthermore, as the virtual photograph to be displayed on the space selection screen, it is desirable that an incentive to participate in the virtual reality space is given to the user by displaying the virtual photograph.

The selection condition is preset and stored in the storage unit 23. The selection condition may be common to all the virtual reality spaces or may be set for each virtual reality space. In a case where the selection condition is common to all the virtual reality spaces, the selection condition is set by, for example, the provider of the service using the service providing server 3. In a case where the selection condition is set for each virtual reality space, for example, each selection condition is set by the space creator of each virtual reality space.

The content of the selection condition may be a description of any condition content. However, as the selection condition, the upper limit number to be selected can be set for one virtual reality space (one piece of space recognition information), but in consideration of viewability of the space selection screen, the upper limit number is desirably common to all the virtual reality spaces. The upper limit number is set by, for example, a service provider using the service providing server 3.

The content of the selection condition is, for example, a condition that selection is performed completely randomly, a condition that selection is performed so that a captured object is not biased to a virtual photograph of a specific object (for example, a condition that a virtual photograph associated with the same captured object as the captured object associated with the selected virtual photograph is excluded, or the like), a condition that selection is performed so that the photographer is not biased to a virtual photograph captured by a specific participant (for example, a condition that a virtual photograph captured by the same photographer as a participant who has captured the selected virtual photograph (hereinafter referred to as “photographer”) is excluded, or the like), a condition that selection is performed so that the event ID associated with the virtual photograph is not biased to a specific event ID (for example, a condition that a virtual photograph associated with the same event ID as the event ID associated with the selected virtual photograph is excluded, or the like), a condition that selection prioritizing a recently captured virtual photograph is performed, a condition that selection prioritizing a virtual photograph captured by a photographer with a longer stay time in the virtual reality space is performed, a condition that selection prioritizing a virtual photograph associated with object information of a captured object with a longer stay time in the virtual reality space is performed, a condition that selection prioritizing a virtual photograph for which the space creator is not the photographer is performed, a condition that selection prioritizing a virtual photograph having a large number of associated captured objects is performed, a condition that display of a virtual photograph selected in advance by the space creator of the virtual reality space is performed, a condition that selection prioritizing a virtual photograph in which a friend of a user displaying the space selection screen is associated as a captured object in a case where a service in which users can be registered as friends with each other is provided is performed, and a condition that selection prioritizing a virtual photograph to which a reaction such as “like” is given in a case where the virtual photograph is published on an SNS is performed, or the like.

Note that the selection condition may be, for example, a combination of a plurality of any selection conditions among the plurality of selection conditions as described above.

When generating the space selection screen display information as described above, the information processing apparatus 2 first acquires the selection condition to be applied to the space recognition information of each virtual reality space from the storage unit 23, selects and extracts a virtual photograph to be displayed on the space selection screen from the plurality of virtual photographs stored in the storage unit 23 according to the selection condition, and generates the space selection screen display information using the extracted virtual photograph.

Note that the function of selecting a virtual photograph by the selection unit 232 is also applicable to the case of selecting a virtual photograph to be displayed on the event selection screen. Since the selection condition, the processing procedure by the information processing apparatus 2, and the like in this case are similar to those in the case of the space selection screen, detailed description thereof will be omitted.

Furthermore, the function of the selection unit in the information processing apparatus 2 can be implemented as long as the photograph information and various types of information are associated in advance by some method. That is, the function of acquiring the space data from the introduction screen is not necessarily based on the association between the photograph information and various types of information performed by the capturing information acquisition unit 221 and the association unit 225 as described above.

### Introduction Screen Display Information Acquisition Unit and Space Data Acquisition Unit

The information processing apparatus 2 may further include the introduction screen display information acquisition unit 233 that acquires introduction screen display information for displaying an introduction screen on which one or more virtual photographs and space recognition information that allows recognizing a virtual reality space in which the virtual photograph is captured or event recognition information that allows recognizing an event held at the time of capturing the virtual photograph in the virtual reality space in which the virtual photograph is captured are displayed, and the space data acquisition unit 234 that, when one virtual photograph is selected from the one or more virtual photographs on the introduction screen, specifies the virtual reality space in which the virtual photograph is captured on the basis of space specifying information or event information associated with the selected virtual photograph, acquires space data that is three-dimensional data of the specified virtual reality space, and transmits the acquired space data to the participant terminal in which an operation of selecting the virtual photograph is performed.

The introduction screen may be any screen as long as one or more virtual photographs are displayed, and the space recognition information or the event recognition information corresponding to each virtual photograph is displayed around each virtual photograph. Therefore, the introduction screen also includes the above-described space selection screen or event selection screen. Furthermore, the introduction screen may include a feed screen, a thumbnail screen, or the like.

The feed screen is, for example, one of services similar to a general SNS provided by the service providing server 3 to the users of the service, and is capable of posting, browsing, citation posting, or reposting a virtual photograph between the users of an arbitrary or specific service, and giving an evaluation such as “like”, a bookmark, or the like.

Furthermore, the thumbnail screen displays, for example, one or more thumbnail images of a virtual reality space or an event in which the user who is displaying the screen is likely to be interested in a limited screen area in a peripheral portion such as the home screen of the service. Similarly to display of recommendation information on a general WEB site or the like, such a function can be implemented by storing the participation history of the virtual reality space or the event for each user, analyzing the user's taste or the like from the history, and selecting a similar virtual reality space or event according to the taste.

For example, when the user of the service accesses the service providing server 3 from the participant terminal 4, the introduction screen can be displayed on the display of the participant terminal 4 first or through a predetermined operation by the user. The introduction screen is a screen displayed so that the user can select a virtual reality space or an event in which the user participates from among the plurality of displayed virtual photographs.

For example, upon being accessed from the participant terminal 4, the service providing server 3 requests the information processing apparatus 2 for introduction screen display information for displaying the introduction screen. This request may include a user ID using the participant terminal 4. Upon acquiring the request for the introduction screen display information from the service providing server 3, the information processing apparatus 2 extracts the virtual photograph to be displayed on the introduction screen from the storage unit 23 according to a predetermined condition, extracts the space recognition information or the event recognition information from the storage unit 23 on the basis of the space specifying information or the event information associated with the virtual photograph, and generates the introduction screen display information according to a predetermined format. Upon acquiring the generated introduction screen display information, the introduction screen display information acquisition unit transmits the acquired introduction screen display information to the participant terminal 4 specified from the user ID. Upon acquiring the introduction screen display information from the information processing apparatus 2, the participant terminal 4 displays the introduction screen on the display.

The user determines a virtual photograph of a virtual reality space or an event in which the user participates with reference to a plurality of virtual photographs displayed on the introduction screen, and performs a selection operation to select the virtual photograph by, for example, a click operation. The selection operation may be to select the space recognition information or the event recognition information displayed around the virtual photograph by a click operation or the like. When the selection operation is performed in the participant terminal 4, the participant terminal 4 transmits the space specifying information of the virtual reality space or the event information of the event associated with the photograph information of the selected virtual image to the information processing apparatus 2. Upon acquiring the space specifying information or the event information, the space data acquisition unit 234 of the information processing apparatus 2 acquires the space data of the virtual reality space indicated by the space specifying information or the space data of the virtual reality space in which the event indicated by the event information is held. Thus, the user can easily participate in the virtual space (the virtual reality space indicated by the space specifying information or the virtual reality space in which the event indicated by the event information is held) in which the virtual photograph is captured with his or her own avatar via the introduction screen.

For example, the storage unit 23 of the information processing apparatus 2 may store all the space data acquired in advance from the service providing server storage unit, and in this case, the space data acquisition unit 234 acquires the space data from the storage unit 23. Alternatively, upon acquiring the space specifying information or the event information from the participant terminal 4, the space data acquisition unit 234 may acquire the space data by accessing the service providing server storage unit of the service providing server 3.

Upon acquiring the space data, the space data acquisition unit 234 transmits the acquired space data to the participant terminal 4. Upon acquiring the space data, the participant terminal 4 displays the virtual reality space represented by the space data on the display.

In the above description, an example has been described in which the space data is immediately transmitted to the participant terminal 4 when the user performs the selection operation of selecting one virtual photograph among the plurality of virtual photographs, but instead of this, when the selection operation is performed, a description screen in detail (hereinafter referred to as a “detailed description screen”) of only the selected virtual reality space or event may be first displayed. In the detailed description screen, in addition to displaying the space recognition information or the event recognition information and one or more virtual photographs associated with (the space specifying information of) the virtual reality space indicated by the space recognition information or (the event information of) the event indicated by the event recognition information, a detailed description of the virtual reality space or the event, such as a description of what content the selected virtual reality space or event has, is displayed. Then, the space data may be transmitted to the participant terminal 4 by selecting the virtual photograph on the detailed description screen.

Here, the detailed description screen is also included in the introduction screen.

Note that the function of acquiring the space data from the introduction screen (including a space selection screen, an event selection screen, and the like) in the information processing apparatus 2 can be implemented as long as the space specifying information or the event information is associated with the photograph information in advance by some method. That is, the function of acquiring the space data from the introduction screen is not necessarily based on the association between the space specifying information or the event information and the photograph information performed by the capturing information acquisition unit 221 and the association unit 225 as described above.

### Information Processing Method

FIG. 7 is a flowchart illustrating an information processing method according to the first embodiment.

The capturing information acquisition unit 221 acquires capturing information including photograph information regarding a virtual photograph captured by a virtual camera used in a virtual reality space and space specifying information specifying the virtual reality space in which the virtual photograph is captured using the virtual camera among a plurality of virtual reality spaces different from each other (step ST1).

The association unit 225 associates the photograph information with the space specifying information (step ST2).

Note that the information processing apparatus 2 only needs to include at least the functions of the capturing information acquisition unit 221 that acquires the capturing information including the photograph information and the space specifying information, and the association unit 225 that associates the photograph information with the space specifying information, and the object information acquisition unit 222, the determination unit 223, the determination result acquisition unit 224, the search key acquisition unit 226 and the search result acquisition unit 227, the notification unit 228, and the display information generation unit 229, or the space selection screen display information acquisition unit 230, the event selection screen display information acquisition unit 231, the selection unit 232, the introduction screen display information acquisition unit 233, or the space data acquisition unit is a function arbitrarily added.

Furthermore, in the above description, it is assumed that at least the participant terminal 4 generates the virtual photograph, and photograph information and the like, which will be described later, related to the virtual photograph are transmitted from the participant terminal 4 to the information processing apparatus 2. However, as described above, since the participant terminal 4 and the service providing server 3 can share the states of the avatar and the object in one and the same virtual reality space in substantially real time, the service providing server 3 can also generate the virtual photograph. In a case where the service providing server 3 generates the virtual photograph, the photograph information and the like may be transmitted from the service providing server 3 to the information processing apparatus 2 instead of being transmitted from the participant terminal 4 to the information processing apparatus 2.

Furthermore, in the above description, it is assumed that all of the functions of the information processing apparatus 2 are provided in one server having a physical configuration independent of the service providing server 3 and the participant terminal 4. However, as described above, in the information processing system 1, a part or all of the functions of the information processing apparatus 2 may be provided in the service providing server 3 or in the participant terminal 4. Furthermore, in the information processing system 1, a part or all of the functions of the information processing apparatus 2 may be provided by the service providing server 3 and the participant terminal 4 in an overlapping manner

For example, the determination unit 223 may be provided in the participant terminal 4 instead of the information processing apparatus 2. In that case, the capturing information acquisition unit 221 may not acquire the camera information from the participant terminal 4. Furthermore, the participant terminal 4 transmits the capturing information and the object information of the in-range object to the capturing information acquisition unit 221 and the object information acquisition unit 222 of the information processing apparatus 2, respectively, and the determination unit included in the participant terminal 4 transmits the determination result to the determination result acquisition unit 224 of the information processing apparatus 2.

Alternatively, the determination unit 223 may be provided in the service providing server 3 instead of the information processing apparatus 2. The configuration in that case is similar to the configuration in a case where the determination unit 223 is provided in the participant terminal 4.

However, the functions of the search key acquisition unit 226 and the search result acquisition unit 227 can be included in the participant terminal 4, but since the participant terminal 4 is usually for personal use, in consideration of the load of the participant terminal 4, in a case where the information processing apparatus 2 does not have those functions or in a case where those functions are included in the information processing system 1 in an overlapping manner with the information processing apparatus 2, it is desirable that the service providing server 3 has those functions.

Furthermore, in the information processing apparatus 2 described above, the object information acquisition unit 222 acquires the object information from the participant terminal 4, but the object information acquisition unit 222 may acquire the space data at the time of capturing from the participant terminal 4 (or the service providing server 3), and perform the in-range object specification on the basis of the camera information and the space data to acquire the result.

As described above, the information processing apparatus 2 according to the first embodiment includes the capturing information acquisition unit 221 that acquires capturing information including photograph information regarding a virtual photograph captured by a virtual camera used in a virtual reality space and space specifying information specifying a virtual reality space in which the virtual photograph is captured using the virtual camera among a plurality of virtual reality spaces different from each other, and the association unit 225 that associates the photograph information with the space specifying information.

Therefore, a program according to the first embodiment that causes one or more computers to function as the information processing apparatus 2 can associate the photograph information (photograph ID or the like) related to the virtual photograph with the space specifying information (space data ID or the like) by utilizing the characteristic of the virtual reality space such that what state the virtual reality space in which the participant currently participates is in is grasped by the computer providing the virtual reality space, by being executed by the one or more computers.

In the information processing apparatus 2 according to the first embodiment, the capturing information acquisition unit 221 may acquire a space data ID that is an ID unique to three-dimensional data of the virtual reality space as the space specifying information, and the association unit 225 may associate the photograph information with the space data ID.

Therefore, the program according to the first embodiment that causes one or more computers to function as the information processing apparatus 2 can specify in which virtual reality space the virtual photograph is captured by the space data ID associated with the photograph information, by being executed by the one or more computers.

The information processing apparatus 2 according to the first embodiment may further include the space selection screen display information acquisition unit 230 that acquires space selection screen display information for displaying a space selection screen on which one virtual reality space for participation can be selected among a plurality of virtual reality spaces different from each other. On this space selection screen, space recognition information that allows recognizing each of a plurality of virtual reality spaces different from each other is displayed, and a virtual photograph associated with space specifying information of the virtual reality space is displayed for each piece of space recognition information.

In this case, the program according to the first embodiment that causes one or more computers to function as the information processing apparatus 2 can provide, by being executed by the one or more computers, a technology that provides the user with the space selection screen on which the space recognition information that allows distinguishing and recognizing each of the virtual reality spaces and the virtual photograph captured in each of the virtual reality spaces are displayed, and allows the user to select one virtual reality space among the plurality of virtual reality spaces different from each other while referring to the virtual photographs. The user can select the virtual reality space in which the user participates while referring to the virtual photograph, which is highly convenient. Furthermore, the space creator of the virtual reality space can make the user more interested in the virtual reality space created by the space creator by displaying the virtual photograph, and a highly convenient technology is provided.

In the information processing apparatus 2 according to the first embodiment, the association unit 225 may associate the event information related to the event held at the time of capturing the virtual photograph in the virtual reality space in which the virtual photograph is captured using the virtual camera with the photograph information.

In this case, the program according to the first embodiment that causes one or more computers to function as the information processing apparatus 2 can associate, by being executed by the one or more computers, photograph information (photograph ID or the like) related to the virtual photograph, space specifying information (space data ID or the like), and event information (event ID or the like) by utilizing the characteristic of the virtual reality space such that what kind of event is held in the virtual reality space in which the participant currently participates is grasped by the computer providing the virtual reality space.

Thus, it is possible to specify, from the virtual photograph, for example, in which event the virtual photograph has been captured and what state the virtual reality space in which the event has been held is in.

In the information processing apparatus 2 according to the first embodiment, the association unit 225 may further associate the event information with the photograph information by including event information related to a related event having a specific relationship with the event in the event information.

In this case, the program according to the first embodiment that causes one or more computers to function as the information processing apparatus 2 can further associate, by utilizing the characteristic of the virtual reality space such that what kind of event is held in the virtual reality space in which the participant currently participates is grasped by the computer providing the virtual reality space, event information of a related event having a specific relationship with the event, in addition to association of photograph information (photograph ID or the like) related to the virtual photograph, space specifying information (space data ID or the like), and event information (event ID or the like), by being executed by the one or more computers.

Thus, it is possible to specify, from the virtual photograph, for example, in which event the virtual photograph has been captured, what state the virtual reality space in which the event has been held is in, and what kind of related events that have a specific relationship with the event there are.

The information processing apparatus 2 according to the first embodiment may further include the event selection screen display information acquisition unit 231 that acquires event selection screen display information for displaying an event selection screen on which one event for participation can be selected among a plurality of different events. On this event selection screen, event recognition information that allows recognizing each of a plurality of events different from each other is displayed, and a virtual photograph associated with the event information is displayed for each piece of the event recognition information.

In this case, the program according to the first embodiment that causes one or more computers to function as the information processing apparatus 2 can provide, by being executed by the one or more computers, a technology that provides the user with the space selection screen on which the event recognition information that allows distinguishing and recognizing each of the events and the virtual photographs captured in the virtual reality space in which the events are held are displayed, and allows the user to select one event among the plurality of events different from each other while referring to the virtual photographs. The user can select the event in which the user participates or the virtual reality space in which the event is held while referring to the virtual photograph, which is highly convenient. In addition, for the event organizer or the space creator of the virtual reality space, by displaying the virtual photograph, it is possible to make the user more interested in the event held by the user or the virtual reality space created by the user, and a highly convenient technology is provided.

The information processing apparatus 2 according to the first embodiment may further include the selection unit 232 that selects, on the basis of a selection condition, a virtual photograph displayed on the space selection screen among a plurality of virtual photographs associated with the space specifying information of the virtual reality space.

In this case, the program according to the first embodiment that causes one or more computers to function as the information processing apparatus 2 can select, by being executed by the one or more computers, a virtual photograph meeting the selection condition from among the plurality of virtual photographs and display the selected virtual photograph on the space selection screen.

In a case where a plurality of virtual photographs is stored in the storage unit 23 in association with the space specifying information of one virtual reality space, it may be impossible to display all the virtual photographs around the space recognition information of the virtual reality space on the space selection screen. Furthermore, as the virtual photograph to be displayed on the space selection screen, it is desirable that an incentive to participate in the virtual reality space is given to the user by displaying the virtual photograph.

By including the selection unit 232, it is possible to select a virtual photograph that matches the selection condition and display the virtual photograph on the space selection screen, the virtual photograph that is more helpful for the user is displayed, a higher incentive can be given to the user for the space creator, and this leads to, also for a service provider, activation of utilization of a service related to the virtual reality space provided by the service provider, so that a technology with high convenience for each party is provided.

The information processing apparatus 2 according to the first embodiment may further include the introduction screen display information acquisition unit 233 that acquires introduction screen display information for displaying an introduction screen on which one or more virtual photographs and space recognition information that allows recognizing a virtual reality space in which the virtual photograph is captured or event recognition information that allows recognizing an event held at the time of capturing the virtual photograph in the virtual reality space in which the virtual photograph is captured are displayed, and the space data acquisition unit 234 that, when one virtual photograph is selected from the one or more virtual photographs on the introduction screen, specifies the virtual reality space in which the virtual photograph is captured on the basis of space specifying information or event information associated with the selected virtual photograph, acquires space data that is three-dimensional data of the specified virtual reality space, and transmits the acquired space data to the participant terminal in which an operation of selecting the virtual photograph is performed.

In this case, the program according to the first embodiment that causes one or more computers to function as the information processing apparatus 2 can provide, by being executed by the one or more computers, a technology of allowing a user to participate in a virtual reality space by an operation of selecting a virtual photograph displayed on the introduction screen.

The information processing apparatus 2 according to the first embodiment that executes the program according to the first embodiment can associate photograph information (photograph ID or the like) related to a virtual photograph with space specifying information (space data ID or the like) by utilizing the characteristic of the virtual reality space such that what state the virtual reality space in which the participant currently participates is in is grasped by the computer providing the virtual reality space.

An information processing method according to the first embodiment includes a step (ST1) of acquiring, by a capturing information acquisition unit 221, capturing information including photograph information regarding a virtual photograph captured by a virtual camera used in a virtual reality space, and space specifying information specifying a virtual reality space in which the virtual photograph is captured using the virtual camera among a plurality of virtual reality spaces different from each other, and a step (ST2) of associating, by an association unit 225, the photograph information with the space specifying information.

Thus, the information processing method according to the first embodiment can associate the photograph information (photograph ID or the like) related to the virtual photograph with the space specifying information (space data ID or the like) by utilizing the characteristic of the virtual reality space such that what state the virtual reality space in which the participant currently participates is in is grasped by the computer providing the virtual reality space.

Hereinafter, embodiments disclosed in the present specification will be collectively described as supplementary notes.

### Supplementary Note 1

A program causing one or more computers to function as an information processing apparatus including:
a capturing information acquisition unit that acquires capturing information including camera information regarding a virtual camera used in a virtual reality space and photograph information regarding a virtual photograph captured by the virtual camera;
an object information acquisition unit that acquires object information regarding, among one or more objects arranged in the virtual reality space, one or more of the objects included in a capturing range of the virtual camera when the virtual photograph is captured;
a determination result acquisition unit that acquires a determination result of determining, on the basis of the camera information and the object information, whether or not to be a captured object shown in the virtual photograph for each of the one or more objects included in the capturing range; and
an association unit that associates the object information with the photograph information on the basis of the determination result.

### Supplementary Note 2

The program according to Supplementary Note 1, in which
the one or more computers are caused to function as the information processing apparatus in which
the association unit associates the object information of the object determined to be the captured object with the photograph information, and does not associate the object information of the non-captured object that is the object determined not to be the captured object with the photograph information.

### Supplementary Note 3

The program according to Supplementary Note 1, in which
the one or more computers are caused to function as the information processing apparatus in which
the association unit distinguishes and associates the object information of the object determined to be the captured object and the object information of a non-captured object that is the object determined not to be the captured object with the photograph information.

### Supplementary Note 4

The program according to Supplementary Note 1, in which
the one or more computers are caused to function as the information processing apparatus in which
the determination result acquisition unit acquires the determination result of determining whether or not to be the captured object for each of one or more avatars as the one or more objects included in the capturing range, and
the association unit associates the object information regarding the avatar with the photograph information on the basis of the determination result.

### Supplementary Note 5

The program according to Supplementary Note 1, in which
the one or more computers are caused to function as the information processing apparatus in which
the association unit associates, in addition to the object information, user specifying information specifying a user of the virtual reality space who has captured the virtual photograph using the virtual camera with the photograph information.

### Supplementary Note 6

The program according to Supplementary Note 1, in which
the one or more computers are caused to function as the information processing apparatus in which
the association unit associates, in addition to the object information, space specifying information specifying the virtual reality space in which the virtual photograph is captured using the virtual camera with the photograph information.

### Supplementary Note 7

The program according to Supplementary Note 1, in which
the one or more computers are caused to function as the information processing apparatus in which
the association unit associates, in addition to the object information, event information related to an event being held at a time of capturing the virtual photograph in the virtual reality space in which the virtual photograph is captured using the virtual camera with the photograph information.

### Supplementary Note 8

The program according to Supplementary Note 1, in which
the one or more computers are caused to function as the information processing apparatus in which
the association unit associates, in addition to the object information or as the object information, sales information regarding sales of the object corresponding to the object information with the photograph information.

### Supplementary Note 9

The program according to Supplementary Note 1, in which
the one or more computers are caused to function as the information processing apparatus in which
the association unit associates search possibility information indicating possibility of search based on metadata including the object information associated with the photograph information with the photograph information for each of the objects.

### Supplementary Note 10

The program according to Supplementary Note 1, in which
the one or more computers are caused to function as the information processing apparatus further including
a search key acquisition unit that acquires the object information as a search key for searching for the photograph information, and
a search result acquisition unit that acquires the photograph information retrieved on the basis of the object information.

### Supplementary Note 11

The program according to Supplementary Note 6, in which
the one or more computers are caused to function as the information processing apparatus further including
a search key acquisition unit that acquires the space specifying information as a search key for searching for the photograph information, and
a search result acquisition unit that acquires the photograph information retrieved on the basis of the space specifying information.

### Supplementary Note 12

The program according to Supplementary Note 9, in which
the one or more computers are caused to function as the information processing apparatus further including
a search key acquisition unit that acquires the object information as a search key for searching for the photograph information, and
a search result acquisition unit that acquires the photograph information that is retrieved on the basis of the object information and associated with the search possibility information indicating that search is possible.

### Supplementary Note 13

The program according to Supplementary Note 1, in which
the one or more computers are caused to function as the information processing apparatus further including
a notification unit that notifies a notification destination specified in accordance with a predetermined notification condition of the photograph information when the object information of the object determined to be the captured object is associated with the photograph information.

### Supplementary Note 14

The program according to Supplementary Note 13, in which
the one or more computers are caused to function as the information processing apparatus in which
the notification unit notifies the notification destination of the photograph information by using an owner, a creator, or a seller of the captured object specified in accordance with the notification condition as the notification destination.

### Supplementary Note 15

The program according to Supplementary Note 1, in which
the one or more computers are caused to function as the information processing apparatus further including
a display information generation unit that generates display information for displaying, when the captured object is designated by an operation of designating the captured object in the virtual photograph performed on the virtual photograph arranged in the virtual reality space, the object information of the designated captured object.

### Supplementary Note 16

The program according to Supplementary Note 3, in which
the one or more computers are caused to function as the information processing apparatus further including
a display information generation unit that generates display information for displaying, when the captured object is designated by an operation of designating the captured object in the virtual photograph performed on the virtual photograph arranged in the virtual reality space, the object information of the designated captured object, and displaying, when the non-captured object is designated by an operation of designating the non-captured object, the object information of the designated non-captured object.

### Supplementary Note 17

An information processing apparatus that executes the program according to any one of Supplementary Notes 1 to 16.

### Supplementary Note 18

An information processing method performed by an information processing apparatus, the information processing method including:
acquiring, by a capturing information acquisition unit, capturing information including camera information regarding a virtual camera used in a virtual reality space and photograph information regarding a virtual photograph captured by the virtual camera;
acquiring, by an object information acquisition unit, object information regarding, among one or more objects arranged in the virtual reality space, one or more of the objects included in a capturing range of the virtual camera when the virtual photograph is captured;
acquiring, by a determination result acquisition unit, a determination result of determining, on the basis of the camera information and the object information, whether or not to be a captured object shown in the virtual photograph for each of the one or more objects included in the capturing range; and
associating, by an association unit, the object information with the photograph information on the basis of the determination result.

Hereinafter, effects and the like of the embodiments illustrated as supplementary notes will be collectively described.

An information processing apparatus 2 according to the first embodiment includes the capturing information acquisition unit 221 that acquires capturing information including camera information regarding a virtual camera used in a virtual reality space and photograph information regarding a virtual photograph captured by the virtual camera, the object information acquisition unit 222 that acquires object information regarding, among one or more objects arranged in the virtual reality space, one or more of the objects (in-range objects) included in a capturing range of the virtual camera when the virtual photograph is captured, the determination result acquisition unit 224 that acquires a determination result of determining, on the basis of the camera information and the object information, whether or not to be a captured object shown in the virtual photograph for each of one or more objects included in the capturing range, and the association unit 225 that associates the object information with the photograph information on the basis of the determination result.

Therefore, the program according to the first embodiment that causes one or more computers to function as the information processing apparatus 2 can associate, by being executed by the one or more computers, the photograph information (photograph ID or the like) regarding the virtual photograph with the object information (object ID or the like) by utilizing the characteristic of the virtual reality space such that the positions of all the objects arranged in the virtual reality space are grasped by the computer providing the virtual reality space.

The associated object information can be used in various modes such as search for a virtual photograph in which a specific object is captured or display of object information of an in-range object.

In the information processing apparatus 2 according to the first embodiment, the association unit 225 associates the object information of the in-range object determined to be the captured object with the photograph information, and does not associate the object information of a non-captured object that is the object determined not to be the captured object with the photograph information.

The program according to the first embodiment that causes one or more computers to function as the information processing apparatus 2 described above can associate, by being executed by the one or more computers, information regarding the captured object determined by utilizing the characteristics of the virtual reality space with the photograph information regarding the virtual photograph.

In the information processing apparatus 2 according to the first embodiment, the association unit 225 may distinguish and associate the object information of the in-range object determined to be the captured object and the object information of a non-captured object that is the object determined not to be the captured object with the photograph information.

The program according to the first embodiment that causes one or more computers to function as the information processing apparatus 2 described above can associate, by being executed by the one or plurality of computers, information regarding the captured object and the non-captured object determined by utilizing the characteristics of the virtual reality space with the photograph information regarding the virtual photograph.

In the information processing apparatus 2 according to the first embodiment, the determination result acquisition unit 224 acquires the determination result of determining whether or not to be the captured object for each of one or more avatars as the one or more objects (in-range objects) included in the capturing range, and the association unit 225 associates the object information regarding the avatar with the photograph information on the basis of the determination result.

The program according to the first embodiment that causes one or more computers to function as the information processing apparatus 2 described above can associate, by being executed by the one or more computers, the information regarding the avatar as the captured object determined by utilizing the characteristics of the virtual reality space with the photograph information regarding the virtual photograph.

In the information processing apparatus 2 according to the first embodiment, the association unit 225 may associate, in addition to the object information, user specifying information specifying a user of the virtual reality space who has captured the virtual photograph using the virtual camera with the photograph information.

The program according to the first embodiment that causes one or more computers to function as the information processing apparatus 2 described above can associate, by being executed by the one or more computers, the information specifying a user of the virtual reality space who has captured the virtual photograph using the virtual camera, for example, information (user ID) specifying a participant who has participated in the virtual reality space as an avatar and captured the virtual photograph by operating the virtual camera as an avatar, with the photograph information regarding the virtual photograph.

The information specifying an associated user can be used in various modes such as search for a virtual photograph captured by a specific user.

In the information processing apparatus 2 according to the first embodiment, the association unit 225 may associate, in addition to the object information, space specifying information specifying the virtual reality space in which the virtual photograph is captured using the virtual camera with the photograph information.

The program according to the first embodiment that causes one or more computers to function as the information processing apparatus 2 described above can associate, by being executed by the one or more computers, the space specifying information (for example, a space data ID of the virtual reality space) for specifying the virtual reality space in which the virtual photograph is captured using the virtual camera with photograph information regarding the virtual photograph.

The associated space specifying information may be utilized in various ways, such as searching for a virtual photograph captured in a particular virtual reality space.

In the information processing apparatus 2 according to the first embodiment, the association unit 225 may associate, in addition to the object information, event information related to an event being held at a time of capturing the virtual photograph in the virtual reality space in which the virtual photograph is captured using the virtual camera with the photograph information.

The program according to the first embodiment that causes one or more computers to function as the information processing apparatus 2 described above can associate, by being executed by the one or more computers, the event information (for example, an event ID, an organizer ID, or both IDs thereof) related to an event held at the time of capturing of a virtual photograph in a virtual reality space in which the virtual photograph is captured using the virtual camera with photograph information associated with the virtual photograph.

In the information processing apparatus 2 according to the first embodiment, the association unit 225 may associate, in addition to the object information or as the object information, sales information regarding sales of the object corresponding to the object information with the photograph information.

The program according to the first embodiment that causes one or more computers to function as the information processing apparatus 2 described above can associate, by being executed by the one or more computers, the sales information regarding the sales of the object with the photograph information regarding the virtual photograph.

The associated sales information can be used in various modes such as display of sales information for an in-range object designated on the virtual photograph.

In the information processing apparatus 2 according to the first embodiment, the association unit 225 may associate search possibility information indicating possibility of search based on metadata including the object information associated with the photograph information with the photograph information for each of the in-range objects.

The program according to the first embodiment that causes one or more computers to function as the information processing apparatus 2 described above can associate, by being executed by the one or more computers, the search possibility information with the information regarding the virtual photograph.

The associated search possibility information can be used at the time of searching for a virtual photograph in which a specific object is captured. The search possibility information can cope with, for example, a problem in a case where the owner or the like of an in-range object does not want another person to acquire the photograph information of the virtual photograph in which the in-range object is captured by the search.

The information processing apparatus 2 according to the first embodiment may include the search key acquisition unit 226 that acquires the object information as a search key for searching for photograph information, and the search result acquisition unit 227 that acquires the photograph information retrieved on the basis of the object information.

The program according to the first embodiment that causes one or more computers to function as the information processing apparatus 2 described above described above can perform, by being executed by the one or more computers, search for photograph information based on a search key and acquire a search result. These functions can be used to provide a virtual photograph search service to the user.

The information processing apparatus 2 according to the first embodiment may include the search key acquisition unit 226 that acquires the space specifying information as a search key for searching for the photograph information, and the search result acquisition unit 227 that acquires the photograph information retrieved on the basis of the space specifying information.

The program according to the first embodiment that causes one or more computers to function as the information processing apparatus 2 described above described above can perform, by being executed by the one or more computers, search for photograph information using the space specifying information (for example, space data ID) as a search key and acquire a search result. These functions can be used to provide a virtual photograph search service using the space specifying information to the user.

The information processing apparatus 2 according to the first embodiment may include the search key acquisition unit 226 that acquires the object information as a search key for searching for photograph information, and the search result acquisition unit 227 that acquires the photograph information that is retrieved on the basis of the object information and associated with the search possibility information indicating that search is possible.

The program according to the first embodiment that causes one or more computers to function as the information processing apparatus 2 described above can acquire, by being executed by the one or more computers, only the photograph information associated with the search possibility information indicating that search is possible at a time of searching for the photograph information based on the search key.

Thus, the program can cope with, for example, a problem in a case where the owner or the like of an in-range object does not want another person to acquire the photograph information of the virtual photograph in which the in-range object is captured by the search.

The information processing apparatus 2 according to the first embodiment may include the notification unit 228 that notifies a notification destination specified in accordance with a predetermined notification condition of the photograph information when the object information of the object determined to be the captured object is associated with the photograph information.

The program according to the first embodiment that causes one or more computers to function as the information processing apparatus 2 described above can notify, by being executed by the one or plurality of computers, the notification destination specified in accordance with the notification condition of the photograph information when the object information is associated with the photograph information. Thus, a user as the notification destination can know that the virtual photograph related to the user has been captured, for example.

In the information processing apparatus 2 according to the first embodiment, the notification unit 228 notifies the notification destination of the photograph information by using an owner, a creator, or a seller of the captured object specified in accordance with the notification condition as the notification destination.

The program according to the first embodiment that causes one or more computers to function as the information processing apparatus 2 described above can notify, by being executed by the one or more computers, an owner, a creator, or a seller of the captured object of the photograph information when the object information is associated with the photograph information. Thus, these persons can know, for example, that a virtual photograph related to themselves has been captured.

The information processing apparatus 2 according to the first embodiment may include the display information generation unit 229 that generates display information for displaying, when the captured object is designated by an operation of designating the captured object in the virtual photograph performed on the virtual photograph arranged in the virtual reality space, the object information of the designated captured object.

The program according to the first embodiment that causes one or more computers to function as the information processing apparatus 2 described above can display, by being executed by the one or more computers, for example, the object information of the captured object on the display of the participant terminal 4 when a participant participating in the virtual reality space using the participant terminal 4 designates a captured object in the virtual photograph.

The information processing apparatus 2 according to the first embodiment may include the display information generation unit 229 that generates display information for displaying, when the captured object is designated by an operation of designating the captured object in the virtual photograph performed on the virtual photograph arranged in the virtual reality space, the object information of the designated captured object, and displaying, when the non-captured object is designated by an operation of designating the non-captured object, the object information of the designated non-captured object.

The program according to the first embodiment that causes one or more computers to function as the information processing apparatus 2 described above can display, by being executed by the one or more computers, for example, the object information of the object on the display of the participant terminal 4 even when a participant participating in the virtual reality space using the participant terminal 4 designates a captured object in the virtual photograph or designates a non-captured object in the virtual photograph.

The information processing apparatus 2 according to the first embodiment that executes the program according to the first embodiment can associate, the photograph information (photograph ID or the like) regarding the virtual photograph with the object information (object ID or the like) by utilizing the characteristic of the virtual reality space such that the positions of all the objects arranged in the virtual reality space are grasped by the computer providing the virtual reality space. The associated object information can be used in various modes such as search for a virtual photograph in which a specific object is captured or display of object information of an in-range object.

An information processing method according to the first embodiment includes acquiring, by a capturing information acquisition unit 221, capturing information including camera information regarding a virtual camera used in a virtual reality space and photograph information regarding a virtual photograph captured by the virtual camera, acquiring, by an object information acquisition unit 222, object information regarding, among one or more objects arranged in the virtual reality space, one or more of the objects (in-range objects) included in a capturing range of the virtual camera when the virtual photograph is captured on the basis of the camera information, acquiring, by a determination result acquisition unit 224, a determination result of determining, on the basis of the object information, whether or not to be a captured object shown in the virtual photograph for each of the one or more objects included in the capturing range, and associating, by an association unit 225, the object information with the photograph information on the basis of the determination result.

Thus, the information processing method according to the first embodiment can associate the photograph information (photograph ID or the like) regarding the virtual photograph with the object information (object ID or the like) by utilizing the characteristic of the virtual reality space such that the positions of all the objects arranged in the virtual reality space are grasped by the computer providing the virtual reality space. The associated object information can be used in various modes such as search for a virtual photograph in which a specific object is captured or display of object information of an in-range object.

1. A non-transitory computer-readable medium storing computer-readable instructions thereon which, when executed by one or more computers operating as an information processing apparatus, cause the information processing apparatus to perform a method, the method comprising:
acquiring capturing information including camera information regarding a virtual camera used in a virtual reality space and photograph information regarding a virtual photograph captured by the virtual camera;
acquiring object information regarding, among one or more objects arranged in the virtual reality space, one or more of the objects included in a capturing range of the virtual camera at a time that the virtual photograph is captured;
acquiring a determination result of determining, based on the camera information and the object information, whether or not to be a captured object shown in the virtual photograph for each of the one or more objects included in the capturing range; and
associating the object information with the photograph information based on the determination result.

2. The non-transitory computer-readable medium according to claim 1, wherein the method further comprises:
associating the object information of the object determined to be the captured object with the photograph information, and not associating the object information of a non-captured object that is the object determined not to be the captured object with the photograph information.

3. The non-transitory computer-readable medium according to claim 1, wherein the method further comprises:
distinguishing and associating the object information of the object determined to be the captured object and the object information of a non-captured object that is the object determined not to be the captured object with the photograph information.

4. The non-transitory computer-readable medium according to claim 1, wherein the method further comprises:
acquiring the determination result of determining whether or not to be the captured object for each of one or more avatars as the one or more objects included in the capturing range, and
associating the object information regarding the avatar with the photograph information based on the determination result.

5. The non-transitory computer-readable medium according to claim 1, wherein the method further comprises:
associating, in addition to the object information, user specifying information specifying a user of the virtual reality space who has captured the virtual photograph using the virtual camera with the photograph information.

6. The non-transitory computer-readable medium according to claim 1, wherein the method further comprises:
associating, in addition to the object information, space specifying information specifying the virtual reality space in which the virtual photograph is captured using the virtual camera with the photograph information.

7. The non-transitory computer-readable medium according to claim 1, wherein the method further comprises:
associating, in addition to the object information, event information related to an event being held at a time of capturing the virtual photograph in the virtual reality space in which the virtual photograph is captured using the virtual camera with the photograph information.

8. The non-transitory computer-readable medium according to claim 1, wherein the method further comprises:
associating, in addition to the object information or as the object information, sales information regarding sales of the object corresponding to the object information with the photograph information.

9. The non-transitory computer-readable medium according to claim 1, wherein the method further comprises:
associating search possibility information indicating possibility of search based on metadata including the object information associated with the photograph information with the photograph information for each of the objects.

10. The non-transitory computer-readable medium according to claim 1, wherein the method further comprises:
acquiring the object information as a search key for searching for the photograph information, and
acquiring the photograph information retrieved based on the object information.

11. The non-transitory computer-readable medium according to claim 6, wherein the method further comprises:
acquiring the space specifying information as a search key for searching for the photograph information, and
acquiring the photograph information retrieved based on the space specifying information.

12. The non-transitory computer-readable medium according to claim 9, wherein the method further comprises:
acquiring the object information as a search key for searching for the photograph information, and
acquiring the photograph information that is retrieved based on the object information and associated with the search possibility information indicating that search is possible.

13. The non-transitory computer-readable medium according to claim 1, wherein the method further comprises:
notifying a notification destination specified in accordance with a predetermined notification condition of the photograph information in a case that the object information of the object determined to be the captured object is associated with the photograph information.

14. The non-transitory computer-readable medium according to claim 13, wherein the method further comprises:
notifying the notification destination of the photograph information by using an owner, a creator, or a seller of the captured object specified in accordance with the notification condition as the notification destination.

15. The non-transitory computer-readable medium according to claim 1, wherein the method further comprises:
generating display information for displaying, in a case that the captured object is designated by an operation of designating the captured object in the virtual photograph performed on the virtual photograph arranged in the virtual reality space, the object information of the designated captured object.

16. The non-transitory computer-readable medium according to claim 3, wherein the method further comprises:
generating display information for displaying, in a case that the captured object is designated by an operation of designating the captured object in the virtual photograph performed on the virtual photograph arranged in the virtual reality space, the object information of the designated captured object, and displaying, in a case that the non-captured object is designated by an operation of designating the non-captured object, the object information of the designated non-captured object.

17. An information processing apparatus that executes the program according to claim 1.

18. An information processing method performed by an information processing apparatus, the information processing method comprising:
acquiring capturing information including camera information regarding a virtual camera used in a virtual reality space and photograph information regarding a virtual photograph captured by the virtual camera;
acquiring object information regarding, among one or more objects arranged in the virtual reality space, one or more of the objects included in a capturing range of the virtual camera at a time that the virtual photograph is captured;
acquiring a determination result of determining, based on the camera information and the object information, whether or not to be a captured object shown in the virtual photograph for each of the one or more objects included in the capturing range; and
associating the object information with the photograph information based on the determination result.

19. The information processing method of claim 18, further comprising:
associating the object information of the object determined to be the captured object with the photograph information, and not associating the object information of a non-captured object that is the object determined not to be the captured object with the photograph information.

20. The information processing method of claim 18, further comprising:
distinguishing and associating the object information of the object determined to be the captured object and the object information of a non-captured object that is the object determined not to be the captured object with the photograph information.
